(19) United States
(12) Patent Application Publication
(10) Pub. No.: US 2022/0315776 A1
(43) Pub. Date: Oct. 6, 2022

(54) SELF-HEALING OR REUSABLE ARTICLE AND PREPARATION METHOD AND USE THEREOF

(71) Applicant: INSTITUTE OF CHEMISTRY, CHINESE ACADEMY OF SCIENCES, Beijing (CN)

(72) Inventors: Yi HOU, Beijing (CN); Guangda ZHU, Beijing (CN); Ning ZHAO, Beijing (CN); Jian XU, Beijing (CN)

(21) Appl. No.: 17/597,077

(22) PCT Filed: Sep. 23, 2020
(86) PCT No.: PCT/CN2020/117109

§ 371 Date: Dec. 23, 2021

(30) Foreign Application Priority Data
Jan. 10, 2020 (CN) 202010028275.1
Jan. 10, 2020 (CN) 202010028278.5

(51) Int. Cl. C09D 7/65; C09D 5/00; C09D 7/40; C09D 183/04; C01B 33/021; B05D 3/02

(52) U.S. Cl. CPC C09D 7/65; C09D 5/00; C09D 7/70; C09D 183/04; C01B 33/021; B05D 3/0254

(57) ABSTRACT

The present invention discloses a self-healing or reusable article and preparation method and use thereof. The present invention discloses a combination system for preparing a self-healing coating material, comprising: (A) a low-surface-energy polymer micelle dispersion; (B) a silane coupling agent hydrolysate; and (C) a base solution. The present invention discloses a composition system for use in a reusable glass-like material or glass-like article, comprising: (i) a mixed dispersion of a silane coupling agent hydrolysate and a base solution; (ii) a low-surface-energy polymer solution; and (iii) a silane coupling agent dispersion. The self-healing or reusable article provided herein has a wide range of application prospect.

The present application claims priority to Chinese Patent No. 202010028278.5 filed with China National Intellectual Property Administration on Jan. 10, 2020 and entitled “TRANSPARENT, HIGH-HARDNESS AND MULTIFUNCTION-INTEGRATABLE SELF-HEALING COATING MATERIAL AND PREPARATION METHOD AND USE THEREOF” and Chinese Patent No. 202010028275.1 filed with China National Intellectual Property Administration on Jan. 10, 2020 and entitled “REUSABLE GLASS-LIKE MATERIAL OR GLASS-LIKE ARTICLE AND PREPARATION METHOD AND RECYCLING METHOD THEREOF”, each of which is incorporated herein by reference in its entirety.

### TECHNICAL FIELD

The present invention relates to the field of functional materials, and particularly to a self-healing or reusable article and preparation method and use thereof.

### BACKGROUND

Self-healing function can prolong the service life of the material and reduce the maintenance cost caused by the damage of the material. Transparent materials capable of self-healing under mild conditions are used in many fields. At present, repeated healing of an elastomeric polymer system can be realized on a molecular level by utilizing hydrogen bonds, coordination bonds, dynamic covalent bonds and the like. However, most flexible self-healing materials are easily worn during the use process, and therefore it is necessary to prepare self-healing materials with good mechanical properties, especially hardness and modulus comparable to those of inorganic rigid systems. Due to the poor mobility of dynamic chemical bonds in rigid systems, it is still a challenge to achieve self-healing of rigid systems under mild conditions.

In addition, most self-healing systems are only limited to introduction of one or two other functions. In order to expand the application field of self-healing materials, large-scale preparation of self-healing material systems that are transparent, rigid and capable of simultaneously introducing multiple functions through a simple and universal preparation process, such as a coating method, shows a wider application prospect.

On the other hand, transparent glass materials are used in many fields. However, many glass wastes are produced in daily life and industrial production. In order to realize the sustainable use of resources, waste glass can be collected and recycled.

At present, the recycling process of glass is complex. First, impurities are removed through careful selection, namely impurities such as metal, ceramics and the like in the recycling materials of glass bottles must be removed since glass container manufacturers need to use high-purity raw materials; second, color sorting is required because colored glass cannot be used in the manufacture of colorless flint glass, and therefore, the cullet after consumption must be subjected to color sorting manually or by machine. Cullet, if used without color sorting, can only be used to produce light green glass containers. Therefore, it is necessary to develop a simple method for preparing glass-like materials or glass-like transparent articles which are convenient for repeated use.

### SUMMARY

The present invention provides a combination system for preparing a self-healing coating material, which comprises:

(A) a low-surface-energy polymer micelle dispersion;

(B) a silane coupling agent hydrolysate; and

(C) a base solution.

According to the technical solution of the present invention, the combination system may further comprise (D) a functional component. For example, the functional component is a functional small molecule, a functional polymer and/or a nanoparticle.

The functional component (D) can be introduced into the system by itself, or introduced into at least one of the component (A), component (B) or component (C) described above and further introduced into the system.

The present invention further provides a self-healing coating material, a self-healing coating or a self-healing article prepared from the combination system described above. Preferably, the self-healing article comprises the self-healing coating.

The present invention further provides a preparation method of the self-healing coating material, which comprises blending a low-surface-energy polymer micelle dispersion (A), a silane coupling agent hydrolysate (B) and a base solution (C) to obtain the self-healing coating material.

According to the technical solution of the present invention, the method comprises:

1) dissolving a low-surface-energy polymer in solvent (a) to obtain a polymer solution;

2) adding solvent (b) into the polymer solution obtained in the step 1) for phase separation to obtain the low-surface-energy polymer micelle dispersion (A);

3) dissolving a silane coupling agent in solvent (b), and heating and stirring under the catalysis of hydrochloric acid, potassium hydroxide or sodium hydroxide to obtain the silane coupling agent hydrolysate (B);

4) dissolving a base in the solvent (b) to obtain the base solution (C); and

5) blending the low-surface-energy polymer micelle dispersion (A), the silane coupling agent hydrolysate (B) and the base solution (C) to obtain the self-healing coating material.

The present invention further provides a preparation method of the self-healing coating or the self-healing article, which comprises:

(a) preparing the self-healing coating material according to the preparation method of the self-healing coating material described above; and

(b) coating the self-healing coating material on a substrate and performing heat treatment to obtain the self-healing coating.

The present invention further provides a self-healing method of the self-healing coating or the self-healing article, which comprises placing the self-healing coating or the self-healing article with scratches on the surface in a mild water vapor environment for healing. In the present invention, the healing can be accomplished quickly, e.g., within a few minutes in the experiments of the present invention.

The present invention further provides use of the self-healing coating material described above in preparation of a self-healing coating or a self-healing article.

The present invention further provides a composition system for use in a reusable glass-like material or glass-like article, which comprises:

(i) a mixed dispersion of a silane coupling agent hydrolysate and a base solution;

(ii) a low-surface-energy polymer solution; and

(iii) a silane coupling agent dispersion.

The present invention further provides a directly reusable glass-like material or glass-like article prepared from the composition system described above.

The present invention further provides a preparation method of the glass-like material or glass-like article, which comprises:

mixing a mixed dispersion of a silane coupling agent hydrolysate and a base solution (i), a low-surface-energy polymer solution (ii) and a silane coupling agent dispersion (iii) to obtain a mixed system, and performing heat treatment and sintering on the mixed system to obtain the glass-like material or glass-like article.

According to the present invention, the preparation method comprises:

A1) mixing a silane coupling agent hydrolysate with an organic base solution to obtain the mixed dispersion (i), wherein

preferably, the silane coupling agent hydrolysate is prepared from a siloxane monomer under catalytic heating conditions;

A2) dissolving a low-surface-energy polymer in solvent (x) to obtain the low-surface-energy polymer solution (ii);

A3) dissolving a silane coupling agent in solvent (y) and stirring at room temperature to obtain the silane coupling agent dispersion (iii);

A4) mixing the mixed dispersion of the silane coupling agent hydrolysate and the base solution (i), the low-surface-energy polymer solution (ii) and the silane coupling agent dispersion (iii) to obtain a mixed system;

A5) performing heat treatment on the mixed system to obtain a silicon-based glass-like gel; and

A6) sintering the silicon-based glass-like gel to obtain the glass-like material or glass-like article.

The present invention further provides a glass-like material or glass-like article prepared by using the method described above.

The present invention further provides a recycling method of the glass-like material or glass-like article described above, which comprises dissolving the glass-like material or glass-like article in water or an aqueous solvent and recycling the obtained sol dispersion.

The aqueous solvent may be selected from a mixed solvent of water and an organic solvent.

The present invention further provides a reutilization method of the glass-like material or glass-like article described above, which comprises: heating the recycled sol dispersion to carry out the molding process and then sintering to obtain the glass-like material or glass-like article, wherein

the sintering process is the same as that in the preparation method.

The present invention further provides a shaping method of the glass-like material or glass-like article described above, which comprises: placing the unsintered glass-like material or glass-like article on the surface of a template with a certain shape, and shaping the glass-like material or glass-like article under 90-150° C. water vapor atmosphere. For example, the shaping method specifically comprises: placing the unsintered glass-like material or glass-like article on the surface of a template with a certain shape, softening the glass under 90-150° C. water vapor atmosphere to allow it to conform to the surface of the template, heating (for example, 60-80° C.) to harden the conformally covered glass, removing the template, and sintering to obtain the shaped glass-like material or glass-like article.

The present invention further provides use of the composition system in preparing reusable glass-like materials or glass-like articles.

Advantageous effects of the present invention:

The self-healing coating material, the self-healing coating or the self-healing article disclosed herein have the following advantages:

1. The preparation method of the transparent, high-hardness and multifunction-integratable self-healing coating material provided herein is simple as the coating material can be prepared only by blending solution at room temperature.

2. The preparation method of the transparent, high-hardness and multifunction-integratable self-healing coating provided herein is simple as the coating can be prepared only by applying corresponding coating material on a transparent substrate via dip coating, spray coating, roll coating or brush coating and then performing heat treatment.

3. The method has universal applicability as the coating material can be coated on the surface of any transparent substrate to impart the characteristics of transparency, high-hardness, self-healing and multifunction-integration.

4. The coating material allows the transmittance of the modified transparent substrate to be greater than or equal to the original transmittance, and allows the pencil hardness of the surface of the transparent substrate to be greater than 9 H; moreover, scratches of several hundred nanometers to micrometers on the surface of the transparent substrate coating can be quickly healed within a few minutes under mild water vapor environment.

5. With the addition of a functional component, in addition to transparency, high-hardness and self-healing, the coating can also have one or more other functions, namely the coating is multifunction-integratable.

The reusable and recyclable glass-like material and glass-like article disclosed herein have the following advantages:

1. The preparation method of the reusable and recyclable glass-like material and glass-like article provided herein is simple as they can be prepared only by blending solution under mild conditions and performing heat treatment and sintering on the blended solution.

2. The glass-like material and glass-like article provided herein are soluble in water or aqueous solvent under heating conditions, and thus the recycling method thereof is simple.

3. The recycled glass-like sol dispersion can be reformed into glass-like articles under certain heating conditions.

4. The glass-like material and glass-like article provided herein have relatively high hardness, toughness and impact resistance.

5. In addition to recyclability, the glass-like material and glass-like article prepared herein have the characteristics of fire resistance, antifouling, heat preservation and ultraviolet resistance, and thus have a wide range of application prospect.

6. The glass-like material and glass-like article disclosed herein can be processed into ware of various shapes under mild water vapor environment, and can be used as substitutes for glass ware.

### BRIEF DESCRIPTION OF THE DRAWINGS

FIG. 1 shows a scanning electron micrograph of the transparent, high-hardness and multifunction-integratable self-healing coating prepared in Example A1 at 50000 times magnification.

FIG. 2 shows a self-healing process of the transparent, high-hardness and multifunction-integratable self-healing coating prepared in Example A1 under 60° C. water vapor environment.

FIG. 3 shows a graph of the transmittance of the glass containing the transparent, high-hardness and multifunction-integratable self-healing coating prepared in Example A1 versus that of the glass without coating.

FIG. 4 shows photographs taken before and after rolling water droplets (a and b) and kerosene droplets (c and d) down from the surface of the prepared transparent, high-hardness, self-healing, hydrophobic and oleophobic coating when the coated glass substrate of Example A1 is at an angle of 30 degrees to the plane.

FIG. 5 shows the spreading and shrinking of fingerprint solution on the coating surface of the glass with the transparent, high-hardness, self-healing and anti-fingerprint coating of Example A1 and on the glass surface of the glass without this coating.

FIG. 6 shows the shrinking and erasing of the oily pen ink on the coating surface of the glass with the transparent, high-hardness, self-healing and anti-graffiti coating of Example A1 and on the glass surface of the glass without this coating.

FIG. 7 shows the nanoindentation test results of the transparent, high-hardness and multifunction-integratable self-healing coating prepared in Example A1.

FIG. 8 shows the 9 H pencil hardness test results of the transparent, high-hardness and multifunction-integratable self-healing coating prepared in Example A1 before and after heat treatment.

FIG. 9 shows a scanning electron micrograph of the surface of the glass-like block prepared in Example B1 at 20000 times magnification.

FIG. 10 shows a photograph of the glass-like block prepared in Example B 1.

FIG. 11 shows a photograph of the glass-like block prepared in Example B1 after dissolution for recycling.

FIG. 12 shows comparison result of hardness and modulus of the glass-like block prepared in Example B1 and a glass-like sample thereof recycled for 10 times.

FIG. 13 shows the change of a bowl-shaped glass-like ware prepared in Example B1 into a cup-shaped glass-like ware through dissolution and reshaping process.

FIG. 14 shows a graph of the transmittance of the glass-like block prepared in Example B1 versus ordinary glass in the ultraviolet and visible light bands.

FIG. 15 shows a fire resistance test of the glass-like block prepared in Example B1.

### DETAILED DESCRIPTION

### [Terms and Definitions]

In the present application, the term “transparent” means that within a certain wavelength range, the transmittance of a substrate after a coating is applied increases by a certain extent or is kept unchanged. Specifically, the substrate is subjected to a transmittance test using a LAMBDA 950 UV-visible spectrophotometer within a certain wavelength range, and the transmittance of the substrate increases by a certain extent or is kept unchanged compared with the original transmittance.

The term “high hardness” means that after the coating is subjected to heat treatment, the pencil hardness of the coating is tested according to the National Standard GB/T6739-2006 of the People's Republic of China, and the pencil hardness of the coating is no less than 9 H.

The term “self-healing” means that under mild water vapor environment, scratches on the coating surface can be quickly healed within a few minutes. Specifically, micron-scale scratches are made on the coating surface by using an iron wire and then exposed to mild water vapor, and the scratches can be completely healed within 3-4 minutes.

The term “multifunction” refers to any one or more other functions except transparency, high-hardness and self-healing, and specifically the other functions can be at least one of anti-fogging, water-resistant, oil-resistant, anti-fingerprint, anti-graffiti, anti-corrosion, anti-blue light, anti-UV, anti-glare, anti-aging, antistatic, anti-reflection, antibacterial, color changeable, electrically conductivity, heat-insulation, sound-insulation, insulation, flame retarding and the like.

### [Combination System]

As described above, the present invention provides a combination system for preparing a self-healing coating material, comprising: (A) a low-surface-energy polymer micelle dispersion; (B) silane coupling agent hydrolysate; and (C) a base solution.

The combination system may further comprise (D) a functional component. For example, the functional component is a functional small molecule, a functional polymer and/or a nanoparticle.

The functional component (D) can be introduced into the system by itself, or introduced into at least one of the component (A), component (B) or component (C) described above and further introduced into the system.

In the combination system, the mass ratio of the low-surface-energy polymer to the silane coupling agent to the base is 40:10:(1-7), such as 40:10:(2-6), and is exemplarily 40:10:3, 40:10:4 or 40:10:5.

In the combination system, the mass ratio of the component (D) to the sum of the components (A), (B) and (C) is 1:50-1:10,000, preferably 1:100-1:1000.

### [Component (A) in the Combination System]

In the low-surface-energy polymer micelle dispersion, the low-surface-energy polymer may be selected from at least one of fluorocarbon resin, silicone resin, and fluorosilicone resin. For example, the fluorocarbon resin includes a low-surface-energy polymer formed by introducing fluorine atoms into a polymer chain, which, for example, may be selected from at least one of polytetrafluoroethylene (PTFE) resin, polyvinylidene fluoride (PVDF) resin, polychlorotrifluoroethylene (FEVE) resin, polyvinyl fluoride (PVF) resin and the like. For example, the silicone resin includes polysiloxane having an Si—O skeleton in the main chain, which, for example, may be selected from at least one of methyl silicone resin, phenyl silicone resin, phenyl vinyl silicone resin, phenyl epoxy silicone resin, borosiloxane resin, poly-n-hexyl triphenyl ethynyl silane resin and the like. For example, the fluorosilicone resin is a type of low-surface-energy material with advantages of both fluorocarbon resin and silicone resin and exhibiting better performance, which, for example, may be selected from at least one of polytrifluoropropylmethylsiloxane, polymethylnonafluorohexylsiloxane, polytridecafluorooctylmethylsiloxane andpolymethylheptadecafluorodecylsiloxane. Exemplarily, the low-surface-energy polymer is selected from at least one of polytetrafluoroethylene resin, polytrifluoropropylmethylsiloxane, polyvinylidene fluoride resin and methyl silicone resin.

The weight-average molecular weight of the fluorocarbon resin is 5000-1,000,000, such as 7500-500,000 or 9000-100,000, and exemplarily 10,000.

The weight-average molecular weight of the silicone resin is 1000-3,000,000, such as 5000-1,000,000 or 7500-100,000, and exemplarily 10,000.

The weight-average molecular weight of the fluorosilicone resin is 3000-3,000,000, such as 5000-1,000,000 or 7500-100,000, and exemplarily 10,000.

The solvent of the low-surface-energy polymer micelle dispersion may be selected from alcohols, ketones and/or esters, and is preferably at least one of methanol, ethanol, isopropanol, acetone, methyl butanone, methyl isobutyl ketone, methyl acetate, ethyl acetate, propyl acetate and the like. Further, the low-surface-energy polymer micelle dispersion comprises two solvents, namely solvent (a) and solvent (b), wherein, the solvent (a) is a solvent capable of dissolving the low-surface-energy polymer, and the solvent (a) is selected from at least one of acetone, methyl butanone, methyl isobutyl ketone, methyl acetate, ethyl acetate, propyl acetate and the like, and is exemplarily ethyl acetate; the solvent (b) is a solvent capable of initiating phase separation so that the low-surface-energy polymer solution forms a low-surface-energy polymer micelle dispersion, and the solvent (b) is, for example, selected from at least one of methanol, ethanol, isopropanol, toluene, cyclohexane, cyclohexanone, ethylene glycol monomethyl ether, ethylene glycol monoethyl ether and ethylene glycol monobutyl ether, and is exemplarily ethanol.

The low-surface-energy polymer micelle dispersion is prepared by dispersing the low-surface-energy polymer in the solvent (a) to form a low-surface-energy polymer solution, adding the low-surface-energy polymer solution into the solvent (b), and then initiating phase separation by the solvent (b).

Micelles in the low-surface-energy polymer micelle dispersion may be negatively or positively charged. When charged, the micelles can be brought into a electrostatic equilibrium state by adding a silane coupling agent bearing opposite charges.

The silane coupling agent is the same as or different from the silane coupling agent in the silane coupling agent hydrolysate (B), and reference can be made to the definition of the component (B) below.

The component (A) may also comprise a precursor of (B), wherein the precursor may be uncharged or may bear charges opposite to those of the polymer micelle.

As described above, the component (A) may further comprise (D) a functional component, which may be a functional small molecule, a functional polymer and/or a nanoparticle.

### [Component (B) in the Combination System]

The silane coupling agent in the silane coupling agent hydrolysate is R₁Si(R₂)(OR)₂, wherein R₁ and R₂ are the same or different and are each independently selected from at least one of —RₐNH₂, —RₐSH, —N(Rₐ)₃, —RₐNR_{b}NH₂,

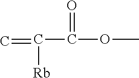

and —ORₐ, wherein Rₐ and R_{b} are the same or different and are each independently selected from C₁₋₈ alkyl, preferably C₁₋₄ alkyl, and exemplarily, Rₐ and Rb are the same or different and are each independently methyl, ethyl or propyl, wherein R are the same or different and are each independently selected from C₁₋₈ alkyl, preferably C₁₋₄ alkyl, and exemplarily, R are the same or different and are each independently methyl or ethyl.

Alternatively, the silane coupling agent is a mixture of a silane coupling agent (a-1) and a silane coupling agent (a-2), wherein one or neither of R₁ and R₂ is OR in the silane coupling agent (a-1), both R₁ and R₂ are OR in the silane coupling agent (a-2), 0≤the content of the (a-2)<100%, and 0<the content of the (a-1)≤100%.

Preferably, the silane coupling agent is selected from positively charged coupling agents, for example from at least one of γ-aminopropyltriethoxysilane, γ-aminopropyltrimethoxysilane, diethylaminomethyltriethoxysilane, 3-(2-aminoethylamino)propyltriethoxysilane, 3-(2-aminoethylamino)propyltrimethoxysilane, γ-(methacryloyloxy) propyltrimethoxy silane, γ-mercaptopropyltrimethoxysilane, and the like. Exemplarily, the silane coupling agent is selected from at least one of γ-aminopropyltriethoxysilane, diethylaminomethyltriethoxysilane, γ-aminopropyltrimethoxysilane and 3-(2-aminoethylamino)propyltrimethoxysilane.

The silane coupling agent hydrolysate comprises solvent (c), wherein the solvent (c) may be selected from at least one of acetone, methyl butanone, methyl isobutyl ketone, methyl acetate, ethyl acetate, propyl acetate, methanol, ethanol, isopropanol, toluene, cyclohexane, cyclohexanone, ethylene glycol monomethyl ether, ethylene glycol monoethyl ether and ethylene glycol monobutyl ether, and is preferably methanol and/or ethanol.

The silane coupling agent hydrolysate further comprises at least one of hydrochloric acid, sodium hydroxide and potassium hydroxide, preferably hydrochloric acid; the acid or base functions as a catalyst, i.e., catalyzes the hydrolysis of the silane coupling agent.

### [Component (C) in the Combination System]

The pH of the base solution of the component (C) is 7.5-8.5.

The base in the component (C) is a weak base, preferably an organic base. For example, the base is selected from at least one of dimethylamine, trimethylamine, ethylamine, diethylamine, triethylamine, benzylamine, aniline, p-toluidine, p-chloroaniline, p-nitroaniline, diphenylamine, pyridine, triethanolamine and urea; more preferably, the base is triethanolamine and/or diphenylamine.

The selection of solvent in the component (C) may be the same as that of the solvent b described above.

Further, in the component (C), the mass ratio of the base to the solvent is 1:5-1:10,000, preferably 1:5-1:1000.

### [Component (D) in the Combination System]

As described above, the component (D) is a functional small molecule, a functional polymer and/or a nanoparticle.

The functional small molecule may be selected from at least one of acrylic acid, ethyl orthosilicate, polypeptide, hyaluronic acid, pyridine, rhodamine, quinoline, quaternary ammonium salt, pyridinium salt, imidazolium salt, isoquinolinium salt, stearic acid, dodecyldimethylbenzylammonium chloride, heptadecafluorodecyltriethoxysilane and 1H,1H,2H,2H-perfluorooctyltrimethoxysilane, for example, from at least one of heptadecafluorodecyltriethoxysilane, stearic acid, 1H,1H,2H,2H-perfluorooctyltrimethoxysilane and dodecyldimethylbenzylammonium chloride.

The functional polymer is selected from at least one of sulfonated polysulfone, polyethersulfone, polyimide, polyetherimide, polyvinyl alcohol, polyethylene glycol, cellulose, polyacrylic acid, polydimethylsiloxane, polytetrafluoroethylene, polyvinylidene fluoride, polyacrylonitrile and polystyrene, for example, from at least one of polyvinyl alcohol and polydimethylsiloxane.

The nanoparticle is selected from at least one of inorganic nanoparticles, organic nanoparticles and metal nanoparticles.

The inorganic nanoparticle may be selected from one or more of silica, titania, zirconium dioxide, zinc oxide, calcium carbonate, alumina, carbon black, graphene, carbon nanotube, fullerene and the like, for example, from silica.

The organic nanoparticle may be selected from one or more of polystyrene, polymethylmethacrylate, polyethylene, polycarbonate, cellulose nanocrystal, and the like.

The metal nanoparticle may be selected from one or more of gold, silver, aluminum, iron, copper and corresponding oxides thereof, and the like.

Exemplarily, the functional component may be selected from at least one of stearic acid, heptadecafluorodecyltriethoxysilane, 1H,1H,2H,2H-perfluorooctyltrimethoxysilane, quaternary ammonium salt, dodecyldimethylbenzylammonium chloride, polyvinyl alcohol, polydimethylsiloxane and silica.

### [Self-Healing Coating Material, Self-Healing Coating or Self-Healing Article]

The present invention further provides a self-healing coating material, a self-healing coating or a self-healing article prepared from the combination system described above. Preferably, the self-healing article comprises the self-healing coating.

Further, the coating is a transparent coating having an average transmittance of 85% or more, preferably 90% or more, for example 91.5%.

Further, the coating has high hardness, and its pencil hardness is no less than 9 H. Further, the coating is capable of self-healing, and scratches of several hundred nanometers to micrometers on the coating can be rapidly healed within 1-10 minutes (such as 2-6 minutes) under mild water vapor environment.

### [Preparation of Self-Healing Coating Material]

The present invention further provides a preparation method of the self-healing coating material, which comprises blending a low-surface-energy polymer micelle dispersion (A), a silane coupling agent hydrolysate (B) and a base solution (C) to obtain the self-healing coating material.

In one embodiment of the present invention, the method comprises:

1) dissolving a low-surface-energy polymer in solvent (a) to obtain a polymer solution;

2) adding solvent (b) into the polymer solution obtained in the step 1) for phase separation to obtain the low-surface-energy polymer micelle dispersion (A);

3) dissolving a silane coupling agent in solvent (c), and heating and stirring under the catalysis of hydrochloric acid, potassium hydroxide or sodium hydroxide to obtain the silane coupling agent hydrolysate (B);

4) dissolving a base in the solvent (b) to obtain the base solution (C); and

5) blending the low-surface-energy polymer micelle dispersion (A), the silane coupling agent hydrolysate (B) and the base solution (C) to obtain the self-healing coating material.

In one embodiment of the present invention, the low-surface-energy polymer, the solvent (a), the solvent (b), the solvent (c), the silane coupling agent and the base are defined as above.

In the step 1) of the present invention, the concentration of the polymer solution is 0.1-300 mg/mL, preferably 25-50 mg/mL, and exemplarily 25 mg/mL, 30 mg/mL or 40 mg/mL.

In the step 1) of the present invention, the dissolution is achieved by stirring at a rate of 200-5000 rpm for 1-10 days, preferably 2-8 days, for example 3 days.

In the step 2) of the present invention, the polymer solution is added dropwise to the solvent (b). For example, the rate of dropwise addition is 1-10 drops per second, preferably 1-5 drops per second.

In the present invention, the volume ratio of the solvent (a) to the solvent (b) is 1:(1-5), for example 1:(1.5-4), and is exemplarily 1:2.

In the step 2) of the present invention, the mass ratio of the polymer solution to the solvent (b) is 1:(20-10,000), for example, 1:(20-1000), preferably 1:(20-500), and exemplarily 1:20, 1:50, 1:60, 1:80 or 1:100.

In the step 2) of the present invention, micelles in the low-surface-energy polymer micelle dispersion (A) may be negatively or positively charged. When charged, the micelles can be brought into a electrostatic equilibrium state by adding a precursor of (B) (i.e., a raw material before the hydrolysis of the silane coupling agent) bearing opposite charges. For example, when the low-surface-energy polymer micelle dispersion (A) exhibits electronegativity, a precursor of (B) which is positively charged may be added to (A). For example, the volume ratio of the precursor of (B) to the low-surface-energy polymer micelle dispersion (A) is not limited as long as it ensures that (A) is a charge stabilization system. For example, the mass ratio can be 1:(10-2000), such as 1:(10-500), and exemplarily 1:100, 1:200, 1:500, 1:800 or 1:1000. Further, the mode of adding is dropwise addition, and the rate of dropwise addition is 1-10 drops per second, preferably 3-6 drops per second.

In the step 3) of the present invention, the mass ratio or volume ratio of the hydrochloric acid, potassium hydroxide or sodium hydroxide to the solvent (b) is 1:100-1:10,000, preferably 1:200-1:2000, and more preferably 1:500-1:1500.

In the step 3) of the present invention, the mass ratio of the silane coupling agent to the solvent (c) is 1:5-1:10,000, preferably 1:7-1:1000, more preferably 1:50-1:800, and exemplarily 1:20, 1:50, 1:100, 1:200, 1:500 or 1:800.

In the step 3) of the present invention, the target temperature of heating is 50-100° C., preferably 70-90° C., and exemplarily 80° C. Further, the stirring rate is 200-5000 rpm, and the stirring time is 1-10 h; preferably, the stirring rate is 500-2500 rpm, and the stirring time is 3-8 h; exemplarily, the stirring rate is 1000 rpm and the stirring time is 8 h.

In the step 4) of the present invention, the mass ratio or volume ratio of the base to the solvent (b) is 1:5-1:10,000, preferably 1:5-1:1000, more preferably 1:10-1:100, and exemplarily 1:20, 1:22, 1:30 or 1:50.

In the step 5) of the present invention, the volume ratio of the low-surface-energy polymer micelle dispersion (A), the silane coupling agent hydrolysate (B) and the base solution (C) is (50-500):(5-50): 1, for example, (80-200):(8-20):1, and exemplarily 100:10:1.

In the step 5) of the present invention, the mass ratio of the silane coupling agent hydrolysate to the low-surface-energy polymer micelle dispersion is 1:5-1:10,000, preferably 1:10-1:1000, and more preferably 1:50-1:200.

In the step 5) of the present invention, the mass ratio of the base solution to the low-surface-energy polymer micelle dispersion is 1:100-1:100,000, preferably 1:200-1:10,000, and more preferably 1:200-1:2000.

In one embodiment of the present invention, the method further comprises step 6): adding a functional component (D) into the self-healing coating material of the step 5). The functional component (D) is defined as above. Further, the mass ratio of the functional component (D) to the coating material is 1:50-1:10,000, preferably 1:100-1:1000, and more preferably 1:200-1:500. The selective addition of the functional component can impart at least one of the following functions to the coating material: anti-fogging, water-resistant, oil-resistant, anti-fingerprint, anti-graffiti, anti-corrosion, anti-blue light, anti-UV, anti-glare, anti-aging, antistatic, anti-reflection, antibacterial, color changeable, electrically conductivity, heat-insulation, sound-insulation, insulation, flame retarding and the like.

### [Preparation of Self-Healing Coating or Self-Healing Article]

The present invention further provides a preparation method of the self-healing coating described above, which comprises:

(a) preparing the self-healing coating material according to the preparation method of the self-healing coating material described above; and

(b) coating the self-healing coating material on a substrate and performing heat treatment to obtain the self-healing coating.

In one embodiment of the present invention, the substrate is selected from transparent inorganic substrates and organic substrates. For example, the substrate may be an inorganic substrate such as ceramic, glass, or the like, or an organic polymer substrate such as polymethylmethacrylate, polyethylene terephthalate, polycarbonate, polypropylene, polystyrene, or the like.

The coating material can be coated on any transparent substrate by a method selected from dipping, dip coating, spray coating, roll coating and brush coating.

Further, the temperature of the heat treatment is 80-450° C., preferably 150-300° C., such as 100° C., 150° C., 200° C. or 250° C.; the treatment time is 0.5-3 h, preferably 1-2 h, such as 1 h, 1.5 h or 2 h. Further, the coating has a thickness of 0.5-5 μm, such as 1-4 μm, and exemplarily 1 μm, 1.5 μm, 2 μm or 3 μm.

### [Self-Healing Method]

The present invention further provides a self-healing method of the self-healing coating or the self-healing article, which comprises placing the coating or article with scratches on the surface in a mild water vapor environment for healing.

The width of the scratch is 100 nm to 150 μm, such as 100 nm to 100 μm. The mild water vapor is produced by evaporation of water at 40-60° C., such as at 45° C., 50° C., 55° C. or 60° C. The coating or article is 1.5-3 cm, such as 2 cm or 3 cm, from the water surface. The healing time is 1-10 min, such as 2-6 min, and exemplarily 4 min.

Further, the healing is performed until the scratch disappears, and the coating or the article is taken out for drying so as to dry the area wetted by the water vapor, for example, by allowing the coating or article to stand at room temperature for drying.

### [Use of Self-Healing Coating Material]

The present invention further provides use of the self-healing coating material described above in preparing a self-healing coating or a self-healing article.

### [Composition System for use in Glass-Like Material or Glass-Like Article]

As described above, the present invention provides a composition system for use in a glass-like material or glass-like article, which comprises:

(i) a mixed dispersion of a silane coupling agent hydrolysate and a base solution;

(ii) a low-surface-energy polymer solution; and

(iii) a silane coupling agent dispersion.

In the composition system, the mass ratio of the mixed dispersion of a silane coupling agent hydrolysate and a base solution (i), the low-surface-energy polymer solution (ii) and the silane coupling agent dispersion (iii) is (100-1500):1:(50-200), such as (300-1000):1:(70-150), and exemplarily 500:1:100, 1000:1:100, 1000:1:50, 800:1:100, 600:1:100 or 900:1:100.

The pH of the composition system is 8.5-14, preferably 8.8-13, and more preferably 9-12.

In the composition system, the mixed dispersion of a silane coupling agent hydrolysate and a base solution (i) comprises a silane coupling agent hydrolysate, an organic base and solvent (z). The silane coupling agent hydrolysate is prepared from a silane coupling agent monomer under catalytic heating conditions.

### [Component (i) in the Composition System]

The mixed dispersion of a silane coupling agent hydrolysate and a base solution (i) comprises a silane coupling agent hydrolysate and a base solution.

The raw materials for preparing the silane coupling agent hydrolysate comprise a siloxane monomer, a catalyst and solvent (z). The siloxane monomer may be selected from siloxanes having hydrophobic end groups, for example, from at least one of methyltriethoxysilane, ethyltriethoxysilane, propyltrimethoxysilane, propyltriethoxysilane, dodecyltriethoxysilane, dodecyltrimethoxysilane, γ-(methacryloyloxy)propyltrimethoxysilane, γ-(methacryloyloxy)propyltriethoxysilane, γ-mercaptopropyltrimethoxysilane, γ-mercaptopropyltriethoxysilane, phenyltrimethoxysilane, phenyltriethoxysilane, and the like; preferably, the siloxane monomer may be selected from at least one of propyltrimethoxysilane, dodecyltriethoxysilane, propyltriethoxysilane, phenyltriethoxysilane, ethyltriethoxysilane and γ-mercaptopropyltrimethoxysilane.

The catalyst is selected from hydrochloric acid or from at least one of sodium hydroxide and potassium hydroxide; for example, the catalyst is hydrochloric acid, sodium hydroxide or potassium hydroxide; exemplarily, the catalyst is hydrochloric acid.

The raw materials for preparing the base solution comprise an organic base and the solvent (z). The organic base is selected from at least one of dimethylamine, trimethylamine, ethylamine, triethylamine, benzylamine, aniline, p-toluidine, p-chloroaniline, p-nitroaniline, diphenylamine, pyridine, triethanolamine and urea; for example, the organic base is at least one of dimethylamine, trimethylamine, ethylamine, triethylamine and aniline; exemplarily, the organic base is triethylamine and/or aniline.

The solvent (z) is selected from at least one of ethanol, acetone, methyl butanone, methyl isobutyl ketone, methyl acetate, ethyl acetate, propyl acetate, methanol, isopropanol, toluene, cyclohexane, cyclohexanone, ethylene glycol monomethyl ether, ethylene glycol monoethyl ether and ethylene glycol monobutyl ether; for example, the solvent (z) is selected from at least one of ethanol, methanol and isopropanol; exemplarily, the solvent (z) is ethanol.

In the mixed dispersion of the silane coupling agent hydrolysate and the base solution, the mass ratio of the siloxane monomer, the catalyst, the organic base and the solvent (z) is (5-10,000): 1:(0.5-100):(100-10,000), such as (100-3000): 1:(0.6-10):(500-5000), and exemplarily 300:1:5:500, 150:1:1:500, 400:3:1.17:700, 150:1:0.75:600, 400:1:0.67:900 or 2500:6:3.75:3000.

### [Component (ii) in the Composition System]

The low-surface-energy polymer solution comprises a low-surface-energy polymer and solvent (x).

The low-surface-energy polymer is selected from at least one of fluorocarbon resin, silicone resin and fluorosilicone resin. For example, the fluorocarbon resin includes a low-surface-energy polymer having fluorine atoms in a polymer chain, and it is preferably at least one of polytetrafluoroethylene (PTFE) resin, polyvinylidene fluoride (PVDF) resin, polychlorotrifluoroethylene (FEVE) resin, polyvinyl fluoride (PVF) resin and the like, and exemplarily polytetrafluoroethylene (PTFE) resin. For example, the silicone resin includes polysiloxane having a Si—O skeleton in the main chain, and it is preferably at least one of methyl silicone resin, phenyl silicone resin, phenyl vinyl silicone resin, phenyl epoxy silicone resin, borosiloxane resin, poly-n-hexyl triphenyl ethynyl silane resin and the like, and exemplarily polymethyl silicone resin or phenyl vinyl silicone resin. For example, the fluorosilicone resin includes a low-surface-energy material with advantages of both fluorocarbon resin and silicone resin and exhibiting better performance, and it is preferably at least one of polytrifluoropropylmethylsiloxane, polymethylnonafluorohexylsiloxane, polytridecafluorooctylmethylsiloxane and polymethylheptadecafluorodecylsiloxane, and is exemplarily polytrifluoropropylmethylsiloxane.

The weight-average molecular weight of the fluorocarbon resin is 5000-1,000,000, such as 8000-500,000 or further 1-100,000, and exemplarily 10,000.

The weight-average molecular weight of the silicone resin is 1000-3,000,000, such as 5000-1,000,000 or further 1-500,000, and exemplarily 10,000.

The weight-average molecular weight of the fluorosilicone resin is 3000-3,000,000, such as 5000-1,500,000 or further 1-750,000, and exemplarily 10,000.

The solvent (x) is selected from ketone solvents and/or ester solvents, such as from at least one of acetone, methyl butanone, methyl isobutyl ketone, methyl acetate, ethyl acetate, propyl acetate and the like, and is exemplarily ethyl acetate.

The concentration of the low-surface-energy polymer solution is 0.1-100 mg/mL, such as 5-25 mg/mL, and exemplarily 10 mg/mL, 12.5 mg/mL, 15 mg/mL, 20 mg/mL or 25 mg/mL.

[Component (iii) in the Composition System]

The silane coupling agent dispersion comprises a silane coupling agent and solvent (y).

The silane coupling agent is R₁Si(R₂)(OR)₂, wherein R₁ and R₂ are the same or different and are each independently selected from at least one of —RₐNH₂, —RₐSH, —N(Rₐ)₃, —RₐNR_{b}NH₂,

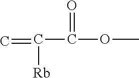

and —ORₐ, wherein Rₐ and R_{b} are the same or different and are each independently selected from C₁₋₈ alkyl, preferably C₁₋₄ alkyl, and exemplarily, Rₐ and R_{b} are the same or different and are each independently methyl or ethyl, wherein R are the same or different and are each independently selected from C₁₋₈ alkyl, preferably C₁₋₄ alkyl, and exemplarily, R are the same or different and are each independently methyl or ethyl.

Alternatively, the silane coupling agent is a mixture of a silane coupling agent (a-1) and a silane coupling agent (a-2), wherein one or neither of R₁ and R₂ is OR in the silane coupling agent (a-1), both R₁ and R₂ are OR in the silane coupling agent (a-2), 0≤the content of the (a-2)<100%, and 0<the content of the (a-1)≤100%.

Preferably, the silane coupling agent may be selected from at least one of γ-aminopropyltriethoxy silane, diethylaminomethyltriethoxysilane, 3 -(2-aminoethylamino)propyltriethoxysilane, 3-(2-aminoethylamino) propyltrimethoxysilane, γ-(methacryloyloxy)propyltrimethoxysilane, γ-mercaptopropyltrimethoxysilane, and the like; exemplarily, the silane coupling agent is 3-(2-aminoethylamino)propyltrimethoxysilane, γ-aminopropyltriethoxysilane, γ-mercaptopropyltrimethoxysilane, 3-(2-aminoethylamino)propyltrimethoxysilane, γ-(methacryloyloxy)propyltrimethoxy silane or diethylaminomethyltriethoxy silane.

The solvent (y) is selected from at least one of acetone, methyl butanone, methyl isobutyl ketone, methyl acetate, ethyl acetate, propyl acetate, methanol, ethanol, isopropanol, toluene, cyclohexane, cyclohexanone, ethylene glycol monomethyl ether, ethylene glycol monoethyl ether and ethylene glycol monobutyl ether; for example, the solvent (y) is selected from at least one of methanol, ethanol and isopropanol; exemplarily, the solvent (y) is ethanol. Preferably, the solvent (y) is the same as the solvent (z).

In the silane coupling agent dispersion, the mass ratio of the silane coupling agent to the solvent (y) is 1 [symbol] 10-5000), such as 1 [symbol] 100-2000), and exemplarily 1:100, 1:300, 1:400, 1:500 or 1:800.

### [Reusable Glass-Like Material or Glass-Like Article]

The present invention provides a reusable glass-like material or glass-like article prepared from the composition system described above.

The glass-like material or glass-like article is a transparent glass-like material or glass-like article.

### [Preparation Method of the Reusable Glass-Like Material or Glass-Like Article]

The present invention further provides a preparation method of the glass-like material or glass-like article, which comprises:

mixing a mixed dispersion of a silane coupling agent hydrolysate and a base solution (i), a low-surface-energy polymer solution (ii) and a silane coupling agent dispersion (iii) to obtain a mixed system, and performing heat treatment and sintering on the mixed system to obtain the glass-like material or glass-like article.

According to an embodiment of the present invention, the preparation method comprises:

A1) blending the silane coupling agent hydrolysate with an organic base solution to obtain the mixed dispersion (i), wherein

preferably, the silane coupling agent hydrolysate is prepared from a siloxane monomer under catalytic heating conditions;

A2) dissolving a low-surface-energy polymer in solvent (x) to obtain the low-surface-energy polymer solution (ii);

A3) dissolving a silane coupling agent in solvent (y) and stirring at room temperature to obtain the silane coupling agent dispersion (iii);

A4) mixing the mixed dispersion of the silane coupling agent hydrolysate and the base solution (i), the low-surface-energy polymer solution (ii) and the silane coupling agent dispersion (iii) to obtain a mixed system;

A5) performing heat treatment on the mixed system to obtain a silicon-based glass-like gel; and

A6) sintering the silicon-based glass-like gel to obtain the glass-like material or glass-like article.

In the present invention, the mixed dispersion of the silane coupling agent hydrolysate and the base solution (i), the low-surface-energy polymer solution (ii), the silane coupling agent dispersion (iii), the siloxane monomer, the organic base, the low-surface-energy polymer, the silane coupling agent, the solvent (x) and the solvent (y) are defined as above.

In the step A1), the mass ratio of the silane coupling agent hydrolysate to the organic base solution is (5-10,000):1, such as (10-1000):1 or further (10-500):1, and exemplarily 30:1, 50:1, 100:1 or 300:1.

The concentration of the silane coupling agent hydrolysate is 50-1000 mg/mL, such as 250-500 mg/mL or further 300-4000 mg/mL.

In the organic base solution, the mass ratio of the organic base to the solvent (z) is 1 [symbol] 10-5000), such as 1 [symbol] 10-1000), and exemplarily 1:100, 1:400, 1:500, 1:600 or 1:800.

In the step A1), the raw materials for preparing the silane coupling agent hydrolysate comprise a siloxane monomer, a catalyst and solvent (z). The siloxane monomer, the catalyst, the solvent (z) and the ratio thereof are defined as above.

In the step A1), the mass ratio of the catalyst to the solvent (z) is 1 [symbol] 100-10,000), such as 1 [symbol] 200-1000) or further 1 [symbol] 300-600).

In the step A1l), the catalytic heating conditions comprise a temperature of 50-100° C., such as 70-90° C., and exemplarily 60° C., 70° C., 80° C. or 90° C. Further, the reaction time of the catalytic heating is 1-10 h, such as 2-8 h, and exemplarily 5 h, 7 h, 8 h or 10 h.

In the step A1), the catalytic heating is performed under a stirring condition, such as at a stirring rate of 200-5000 rpm or further 500-1500 rpm, and exemplarily 1000 rpm or 2000 rpm.

In the step A2), the low-surface-energy polymer, the solvent (x) and the low-surface-energy polymer solution (ii) are defined as above.

In the step A2), the dissolving process is a dissolving process with stirring. For example, the stirring rate is 200-5000 rpm or further 500-3000rpm, and exemplarily 2000 rpm or 3000 rpm. Further, the stirring time is 1-10 days, such as 2-8 days, and exemplarily 3 days, 5 days, 8 days or 10 days.

In the step A3), the silane coupling agent, the solvent (y) and the silane coupling agent dispersion (iii) are defined as above.

In the step A4), the mass ratio of the mixed dispersion of the silane coupling agent hydrolysate and the base solution (i) to the silane coupling agent dispersion (iii) is (10-500):1, such as (20-300):1, and exemplarily 30:1, 50:1, 100:1 or 300:1.

In the step A5), the temperature of the heat treatment is 80-200° C., such as 100-160° C., and exemplarily 100° C. Further, the time of the heat treatment is 1-5 h, such as 2-4 h, and exemplarily 3 h or 5 h.

In step A6), the sintering is performed under an inert atmosphere. For example, the inert atmosphere is at least one of nitrogen, argon and the like, and is preferably nitrogen.

In the step A6), the temperature of the sintering is 200-600° C., such as 300-500° C., and exemplarily 400° C. Further, the time of the heat treatment is 0.5-5 h, such as 1-4 h, and exemplarily 1 h, 2 h or 3 h.

### [Recycling Method of the Reusable Glass-Like Material or Glass-Like Article]

The present invention further provides a recycling method of the glass-like material or glass-like article described above, which comprises dissolving the glass-like material or glass-like article in water or an aqueous solvent and recycling the obtained sol dispersion.

The aqueous solvent may be selected from a mixed solvent of water and an organic solvent. Preferably, the organic solvent is an organic solvent which is miscible with water, such as ethanol.

### [Reutilization Method of the Reusable Glass-Like Material or Glass-Like Article]

The present invention further provides a reutilization method of the glass-like material or glass-like article described above, which comprises: heating the recycled sol dispersion to carry out the molding process and then sintering to obtain the glass-like material or glass-like article, wherein

the target temperature of heating is 60-80° C., such as 60-70° C., and exemplarily 60° C. The purpose of heating is to remove water or aqueous solvent from the sol dispersion.

The sintering is the same as that in the preparation method.

### [Shaping Method of the Reusable Glass-Like Material or Glass-Like Article]

The present invention further provides a shaping method of the glass-like material or glass-like article described above, which comprises: placing the glass-like material or glass-like article in a template and shaping the glass-like material or glass-like article under water vapor atmosphere at 90-150° C. (e.g., 100-120° C., exemplarily 100° C.).

For example, the shaping method specifically comprises: placing the unsintered glass-like material or glass-like article on the surface of a template with a certain shape, softening the glass under 90-150° C. water vapor atmosphere to allow it to conform to the surface of the template, heating (for example, 60-80° C.) to harden the conformally covered glass, removing the template, and sintering to obtain the shaped glass-like material or glass-like article.

### [Use of the Composition System]

The present invention further provides use of the composition system in preparing reusable glass-like materials or glass-like articles.

The technical solution of the present invention will be further illustrated in detail with reference to the following specific examples. It should be understood that the following examples are merely exemplary illustration and explanation of the present invention, and should not be construed as limiting the protection scope of the present invention. All techniques implemented based on the aforementioned contents of the present invention are encompassed within the protection scope of the present invention.

Unless otherwise specified, the raw materials and reagents used in the following examples are all commercially available products or can be prepared by known methods.

### EXAMPLE A1

1) Polytetrafluoroethylene resin (2.5 g) with a weight-average molecular weight of 10,000 as a low-surface-energy polymer was dissolved in ethyl acetate (100 mL), and then the mixture was magnetically stirred at room temperature at a rate of 1000 rpm for 3 days to obtain a polytetrafluoroethylene solution, namely solution (a), the concentration of which was 25 mg/mL.

2) Ethanol as solvent (b) was added dropwise into the solution (a) obtained in the step 1) at a rate of 1 drop per second, and the mass ratio of the solution (a) to the solvent (b) was 1:20. Phase separation was initiated by the solvent (b) to obtain a dispersion containing polytetrafluoroethylene micelles, namely system (c). The dispersion containing the polytetrafluoroethylene micelles exhibited electronegativity.

3) Electropositive 3-(2-aminoethylamino)propyltrimethoxysilane (5 mL) was added dropwise to the system © obtained in the step 2) at 5 drops per second to obtain dispersion ©, wherein the mass ratio of 3-(2-aminoethylamino)propyltrimethoxysilane to the system © was 1:200. Due to electrostatic interaction, 3-(2-aminoethylamino)propyltrimethoxysilane, as a shell layer, was adsorbed onto the surface of the polytetrafluoroethylene micelles.

4) Under the catalysis of hydrochloric acid (200 μL), 3-(2-aminoethylamino)propyltrimethoxysilane (30 mL) was dissolved in ethanol (300 mL), and then the mixture was heated at 80° C. and stirred at a rate of 1000 rpm for 8 h to obtain a hydrolytic dispersion of 3-(2-aminoethylamino)propyltrimethoxysilane, namely hydrolysate (f).

5) Triethanolamine (5 mL) as an organic base was dissolved in ethanol (100 mL) to obtain a solution of triethanolamine in ethanol, namely solution (g), the pH of which was 8.0.

6) The dispersion © (100 mL) prepared in the step 3), the hydrolysate (f) (10 mL) prepared in the step 4) and the solution (g) (1 mL) prepared in the step 5) were blended to obtain transparent, high-hardness and self-healing coating material (h).

7) The transparent, high-hardness and self-healing coating material (h) prepared in the step 6) was mixed with heptadecafluorodecyltriethoxysilane (100 μL) and polydimethylsiloxane (200 μL) to obtain coating material (I). The coating material (I), in addition to transparency, high-hardness and self-healing, has the functions of water-resistant, oil-resistant, anti-fingerprint and anti-graffiti.

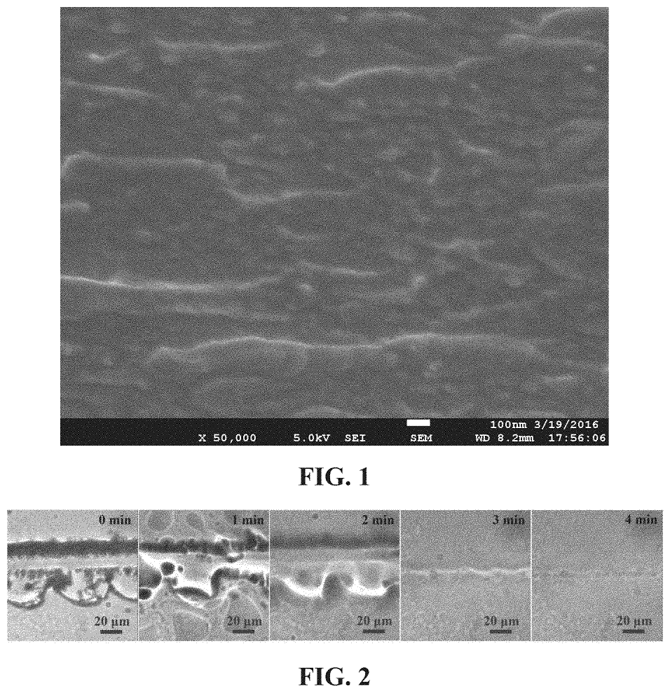

The self-healing coating material obtained in the step 7) was coated on a glass substrate by dip coating, and then subjected to heat treatment at 150° C. for 2 h to obtain a coating with a thickness of 3 μm on the glass substrate (the surface structure of the coating is shown in FIG. 1).

The coating obtained by curing of the coating material (I) has the following properties:

the hardness is no less than 0.74 Gpa and the Young's modulus is 6.9 Gpa.

A scratch having a width of 150 μm was made on the coating surface of the glass substrate with a wire mesh, and then exposed to vapor of water generated at 60° C., wherein the coating was 3 cm from the water surface. The healing was performed until the scratch disappeared, and then the article was taken out and allowed to stand at room temperature for drying so as to dry the area wetted by the water vapor. As can be seen from FIG. 2, the scratch was gradually healed and became smaller as time passed, and when the heating treatment reached 4 min, the scratch basically disappeared, and the self-healing of the coating was basically completed.

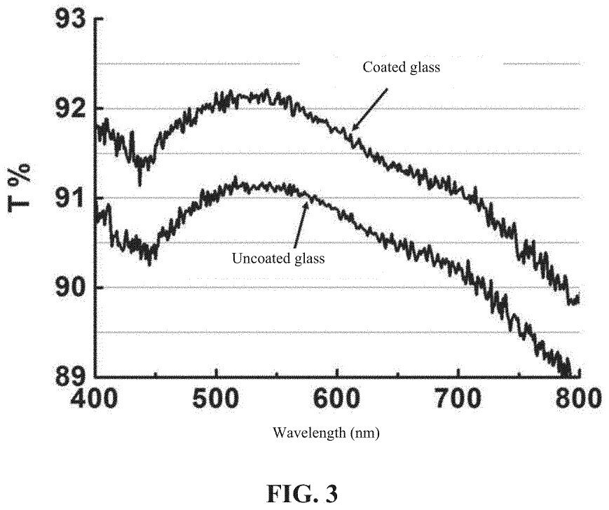

FIG. 3 shows a graph of the transmittance of a glass coated with the coating of the example versus that of a glass substrate without coating, demonstrating that the coating can increase the transmittance of the glass substrate by about 1%.

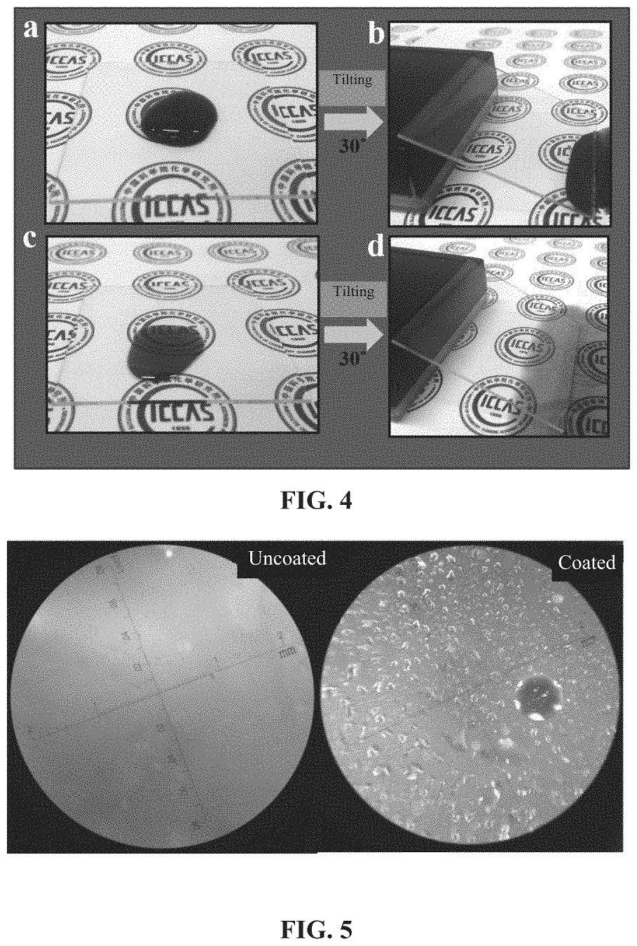

The glass coated with the coating of the example was investigated for its hydrophobicity and oleophobicity (as shown in FIG. 4). It can be seen from a and b in FIG. 4 that the coating of this example has excellent water-resistant property, and it can be seen from c and d in FIG. 4 that the coating of this example has excellent oil-resistant property.

The anti-fingerprint property of the glass coated with the coating of the example was investigated (as shown in FIG. 5). For a glass substrate without coating, almost all the fingerprint liquid spread on the surface of the glass substrate, while in the case of the glass coated with the coating of the example, the fingerprint liquid was in a dropwise dispersion and has poor spreadability, showing that the coating of the example has excellent anti-fingerprint property.

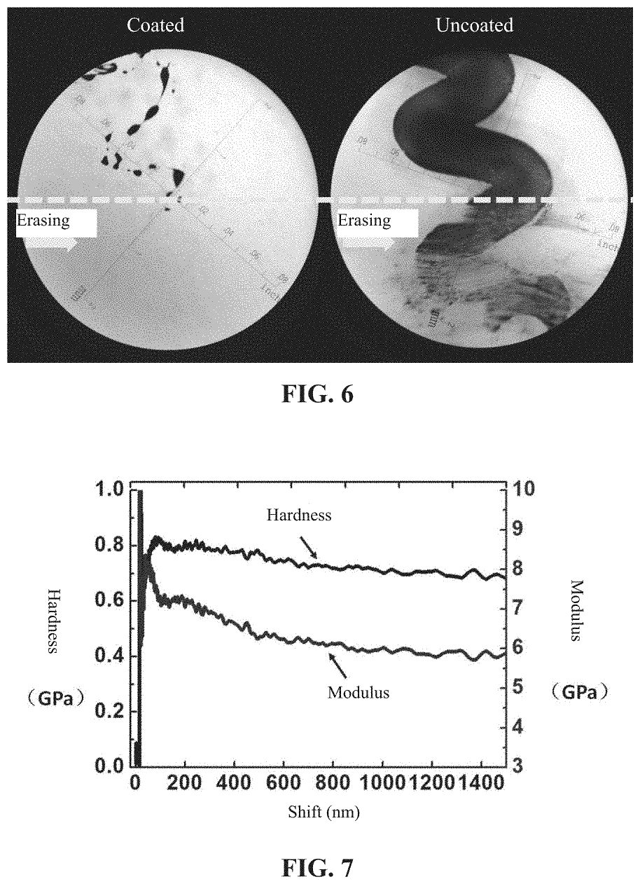

The anti-graffiti property of the glass coated with the coating of the example was investigated (as shown in FIG. 6). For a glass substrate without coating, the oil pen ink spread well on the surface of the glass substrate and could not be completely erased, while in the case of the glass coated with the coating of the example, the oil pen ink was in a shrinking state as droplets and could be almost completely erased, showing that the coating of the example has excellent anti-graffiti property.

FIG. 7 shows the nanoindentation test results of the transparent, high-hardness and self-healing coating prepared in Example A1. The results show that the coating surface has a hardness of 7.3 Gpa and a modulus of 6.9 Gpa as measured by continuous stiffness measurement.

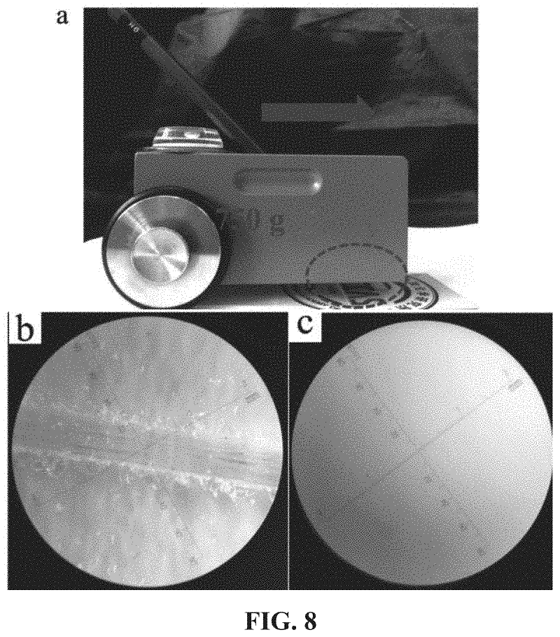

FIG. 8 shows the 9 H pencil hardness test results of the transparent, high-hardness and self-healing coating prepared in Example A1 before and after heat treatment. The results show that: according to the National Standard GB/T6739-2006, the pencil with the hardness of 2 H can make obvious scratches on the surface of the coating before the heat treatment, which shows that the hardness of the coating before the heat treatment is less than 2 H, and the pencil with the hardness of 9 H cannot make scratches on the surface of the coating after the heat treatment, which shows that the hardness of the coating after the heat treatment is more than 9 H.

### EXAMPLE A2

1) Polytrifluoropropylmethylsiloxane (5 g) with a weight-average molecular weight of 10,000 as a low-surface-energy polymer was dissolved in ethyl acetate (100 mL), and then the mixture was magnetically stirred at room temperature at a rate of 1000 rpm for 3 days to obtain a polytrifluoropropylmethylsiloxane solution, namely solution (a), the concentration of which was 50 mg/mL.

2) Ethanol as solvent (b) was added dropwise into the solution (a) obtained in the step 1) at a rate of 1 drop per second, and the mass ratio of the solution (a) to the solvent (b) was 1:100. Phase separation was initiated by the solvent (b) to obtain a dispersion containing polytrifluoropropylmethylsiloxane micelles, namely system (c). The dispersion containing the polytrifluoropropylmethylsiloxane micelles exhibited electronegativity.

3) Electropositive 3-(2-aminoethylamino)propyltrimethoxysilane (5 mL) was added dropwise to the system © obtained in the step 2) at a rate of 5 drops per second to obtain dispersion ©, wherein the mass ratio of 3-(2-aminoethylamino)propyltrimethoxysilane to the system © was 1:300. Due to electrostatic interaction, 3-(2-aminoethylamino)propyltrimethoxysilane, as a shell layer, was adsorbed onto the surface of the polytrifluoropropylmethylsiloxane micelles.

4) Under the catalysis of hydrochloric acid (200 μL), 3-(2-aminoethylamino)propyltrimethoxysilane (30 mL) was dissolved in ethanol (300 mL), and then the mixture was heated at 80° C. and stirred at a rate of 1000 rpm for 8 h to obtain a sol dispersion of 3-(2-aminoethylamino)propyltrimethoxysilane, namely hydrolysate (f).

5) Triethanolamine (5 mL) as an organic base was dissolved in ethanol (200 mL) to obtain a solution (g) of triethanolamine in ethanol, the pH of which was 7.5.

6) The dispersion © (100 mL) prepared in the step 3), the hydrolysate (f) (10 mL) prepared in the step 4) and the solution (g) (1 mL) prepared in the step 5) were blended to obtain transparent, high-hardness and self-healing coating material (h).

7) The transparent, high-hardness and self-healing coating material (h) prepared in the step 6) was mixed with heptadecafluorodecyltriethoxysilane (100 μL) and polydimethylsiloxane (200 μL), which could allow the coating to have the functions of water-resistant, oil-resistant, anti-fingerprint and anti-graffiti in addition to transparency, high-hardness and self-healing.

The self-healing coating material obtained in the step 7) was coated on a polymethylmethacrylate substrate by dip coating, and then subjected to heat treatment at 100° C. for 2 h to obtain a coating with a thickness of 2 μm on the polymethylmethacrylate substrate; the pencil hardness of the coating was no less than 9 H.

A scratch having a width of 100 μm was made on the coating surface of the polymethylmethacrylate substrate with a wire mesh, and then exposed to vapor of water generated at 50° C., wherein the coating was 2 cm from the water surface. The healing was performed until the scratch disappeared, and then the article was taken out and allowed to stand at room temperature for drying so as to dry the area wetted by the water vapor.

### EXAMPLE A3

1) Polytrifluoropropylmethylsiloxane (3.5 g) with a weight-average molecular weight of 10,000 as a low-surface-energy polymer was dissolved in ethyl acetate (100 mL), and then the mixture was magnetically stirred at room temperature at a rate of 1000 rpm for 3 days to obtain a polytrifluoropropylmethylsiloxane solution, namely solution (a), the concentration of which was 35 mg/mL.

2) Ethanol as solvent (b) was added dropwise into the solution (a) obtained in the step 1) at a rate of 1 drop per second, and the mass ratio of the solution (a) to the solvent (b) was 1:80. Phase separation was initiated by the solvent (b) to obtain a dispersion containing polytrifluoropropylmethylsiloxane micelles, namely system (c). The dispersion containing the polytrifluoropropylmethylsiloxane micelles exhibited electronegativity.

3) Electropositive γ-aminopropyltrimethoxysilane (5 mL) was added dropwise to the system © obtained in the step 2) at a rate of 5 drops per second to obtain dispersion ©, wherein the mass ratio of γ-aminopropyltrimethoxysilane to the system © was 1:300. Due to electrostatic interaction, γ-aminopropyltrimethoxysilane, as a shell layer, was adsorbed onto the surface of the polytrifluoropropylmethylsiloxane micelles.

4) Under the catalysis of hydrochloric acid (200 μL), γ-aminopropyltrimethoxysilane (30 mL) was dissolved in ethanol (300 mL), and then the mixture was heated at 80° C. and stirred at a rate of 1000 rpm for 8 h to obtain a sol dispersion of γ-aminopropyltrimethoxysilane, namely hydrolysate (f).

5) Triethanolamine (5 mL) as an organic base was dissolved in ethanol (100 mL) to obtain a solution (g) of triethanolamine in ethanol, the pH of which was 8.

6) The dispersion © (100 mL) prepared in the step 3), the hydrolysate (f) (10 mL) prepared in the step 4) and the solution (g) (1 mL) prepared in the step 5) were blended to obtain transparent, high-hardness and self-healing coating material (h).

7) The transparent, high-hardness and self-healing coating material (h) prepared in the step 6) was mixed with a silica dispersion (100 μL) with a particle size of 200 nm and stearic acid (2.0 g), which could allow the coating to have the function of changing color between white and transparent in addition to transparency, high-hardness and self-healing.

Any self-healing coating material described above was coated on a ethylene terephthalate substrate by spray coating, and then subjected to heat treatment at 100° C. for 2 h to obtain a coating with a thickness of 1 μm on the ethylene terephthalate substrate; the pencil hardness of the coating was no less than 9 H.

A scratch having a width of 150 μm was made on the coating surface of the ethylene terephthalate substrate with a wire mesh, and then exposed to vapor of water generated at 45° C., wherein the coating was 3 cm from the water surface. The healing was performed until the scratch disappeared, and then the article was taken out and allowed to stand at room temperature for drying so as to dry the area wetted by the water vapor.

### EXAMPLE A4

1) Polyvinylidene fluoride resin (6.5 g) with a weight-average molecular weight of 10,000 as a low-surface-energy polymer was dissolved in ethyl acetate (100 mL), and then the mixture was magnetically stirred at room temperature at a rate of 1000 rpm for 3 days to obtain a polyvinylidene fluoride resin solution, namely solution (a), the concentration of which was 65 mg/mL.

2) Ethanol as solvent (b) was added dropwise into the solution (a) obtained in the step 1) at a rate of 1 drop per second, and the mass ratio of the solution (a) to the solvent (b) was 1:700. Phase separation was initiated by the solvent (b) to obtain a dispersion containing polyvinylidene fluoride micelles, namely system (c). The dispersion containing the polyvinylidene fluoride micelles exhibited electronegativity.

3) Electropositive diethylaminomethyltriethoxysilane (5 mL) was added dropwise to the system © obtained in the step 2) at a rate of 5 drops per second to obtain dispersion ©, wherein the mass ratio of diethylaminomethyltriethoxysilane to the system © was 1:50. Due to electrostatic interaction, diethylaminomethyltriethoxysilane, as a shell layer, was adsorbed onto the surface of the polyvinylidene fluoride micelles.

4) Under the catalysis of hydrochloric acid (200 μL), diethylaminomethyltriethoxysilane (30 mL) of the step 3) was dissolved in ethanol (300 mL), and then the mixture was heated at 80° C. and stirred at a rate of 1000 rpm for 8 h to obtain a sol dispersion of diethylaminomethyltriethoxysilane, namely hydrolysate (f).

5) Triethylamine (5 mL) as an organic base was dissolved in ethanol (100 mL) to obtain a solution (g) of triethylamine in ethanol, the pH of which was 8.

6) The dispersion © (100 mL) prepared in the step 3), the hydrolysate (f) (10 mL) prepared in the step 4) and the solution (g) (1 mL) prepared in the step 5) were blended to obtain transparent, high-hardness and self-healing coating material (h).

7) The transparent, high-hardness and self-healing coating material (h) prepared in the step 6) was mixed with polyvinyl alcohol (1.0 g) and 1H,1H,2H,2H-perfluorooctyltrimethoxysilane (2.0 g), which could allow the coating to have the functions of anti-fogging and anti-smudge in addition to transparency, high-hardness and self-healing.

Any self-healing coating material described above was coated on a ceramic substrate by spray coating, and then subjected to heat treatment at 200° C. for 1 h to obtain a coating with a thickness of 2.5 μm on the ceramic substrate; the pencil hardness of the coating was no less than 9 H.

A scratch having a width of 200 μm was made on the coating surface of the ceramic substrate with a wire mesh, and then exposed to vapor of water generated at 60° C., wherein the coating was 2 cm from the water surface. The healing was performed until the scratch disappeared, and then the article was taken out and allowed to stand at room temperature for drying so as to dry the area wetted by the water vapor.

### EXAMPLE A5

1) Methyl silicone resin (5.5 g) with a weight-average molecular weight of 10,000 as a low-surface-energy polymer was dissolved in ethyl acetate (200 mL), and then the mixture was magnetically stirred at room temperature at a rate of 1000 rpm for 3 days to obtain a methyl silicone resin solution, namely solution (a), the concentration of which was 55 mg/mL.

2) Ethanol as solvent (b) was added dropwise into the solution (a) obtained in the step 1) at a rate of 1 drop per second, and the mass ratio of the solution (a) to the solvent (b) was 1:800. Phase separation was initiated by a nonsolvent to obtain a dispersion containing methyl silicone resin micelles, namely system (c). The dispersion containing the polyvinylidene fluoride micelles exhibited electronegativity.

3) Electropositive γ-aminopropyltriethoxysilane (10 mL) was added dropwise to the system © obtained in the step 2) at a rate of 10 drops per second to obtain a dispersion ©, wherein the mass ratio of γ-aminopropyltriethoxysilane to the system © was 1:80. Due to electrostatic interaction, γ-aminopropyltriethoxysilane, as a shell layer, was adsorbed onto the surface of the methyl silicone resin micelles.

4) Under the catalysis of hydrochloric acid (400 μL), γ-aminopropyltriethoxysilane (60 mL) of the step 3) was dissolved in ethanol (600 mL), and then the mixture was heated at 80° C. and stirred at a rate of 1000 rpm for 8 h to obtain a sol dispersion of γ-aminopropyltriethoxysilane, namely hydrolysate (f).

5) Diphenylamine (10 mL) as an organic base was dissolved in ethanol (200 mL) to obtain a solution (g) of diphenylamine in ethanol, the pH of which was 8.5.

6) The dispersion © (200 mL) prepared in the step 3), the hydrolysate (f) (20 mL) prepared in the step 4) and the solution (g) (2 mL) prepared in the step 5) were blended to obtain transparent, high-hardness and self-healing coating material (h).

7) The transparent, high-hardness and self-healing coating material (h) prepared in the step 6) was mixed with a quaternary ammonium salt antibacterial agent (dodecyldimethylbenzylammonium chloride as an effective ingredient) (2.0 g) and silica dispersion with a particle size of 30 nm (2 mL), which could allow the coating to have the functions of antibacterial and anti-reflection in addition to transparency, high-hardness and self-healing.

Any self-healing coating material described above was coated on a polycarbonate substrate by spray coating, and then subjected to heat treatment at 200° C. for 1 h to obtain a coating with a thickness of 2 μm on the polycarbonate substrate; the pencil hardness of the coating was no less than 9 H.

A scratch having a width of 100 μm was made on the coating surface of the polycarbonate substrate with a wire mesh, and then exposed to vapor of water generated at 60° C., wherein the coating was 3 cm from the water surface. The healing was performed until the scratch disappeared, and then the coating or article was taken out and allowed to stand at room temperature for drying so as to dry the area wetted by the water vapor.

### EXAMPLE B1

1) Under the catalysis of hydrochloric acid, propyltrimethoxysilane was dissolved in ethanol, and then the mixture was heated at 80° C. and stirred at a rate of 2000 rpm for 10 h to obtain a ydrolytic dispersion of propyltrimethoxysilane, namely hydrolysate (a), wherein the mass ratio of hydrochloric acid to propyltrimethoxysilane to ethanol was 1:300:500.

2) Triethanolamine as an organic base was dissolved in ethanol to obtain a solution of triethanolamine in ethanol, namely solution (b), wherein the mass ratio of triethanolamine to ethanol was 1:100.

3) Polytetrafluoroethylene resin (2.5 g) with a weight-average molecular weight of 10,000 as a low-surface-energy polymer was dissolved in ethyl acetate (200 mL), and then the mixture was magnetically stirred at room temperature at a rate of 1000 rpm for 3 days to obtain a polytetrafluoroethylene solution, namely solution ©.

4) 3-(2-aminoethylamino)propyltrimethoxysilane was added into ethanol to obtain a silane coupling agent dispersion, namely dispersion (d), wherein the mass ratio of 3-(2-aminoethylamino)propyltrimethoxysilane to ethanol was 1:100.

5) The hydrolysate (a) prepared in the step 1) and the solution (b) prepared in the step 2) were blended in a mass ratio of 300:1 to obtain a mixed dispersion, namely dispersion ©.

6) The dispersion © prepared in the step 5), the solution © prepared in the step 3) and the dispersion (d) prepared in the step 4) were blended in a mass ratio of 500:1:100 to obtain a mixed dispersion, namely dispersion (f), the pH of which was 9.0.

7) The dispersion (f) obtained in the step 6) was placed into any mold and then subjected to heat treatment at 100° C. for 5 h to obtain a silicon-based glass-like gel block.

8) The glass gel block was sintered at 400° C. for 2 h under nitrogen atmosphere to obtain a reusable silicon-based glass-like block.

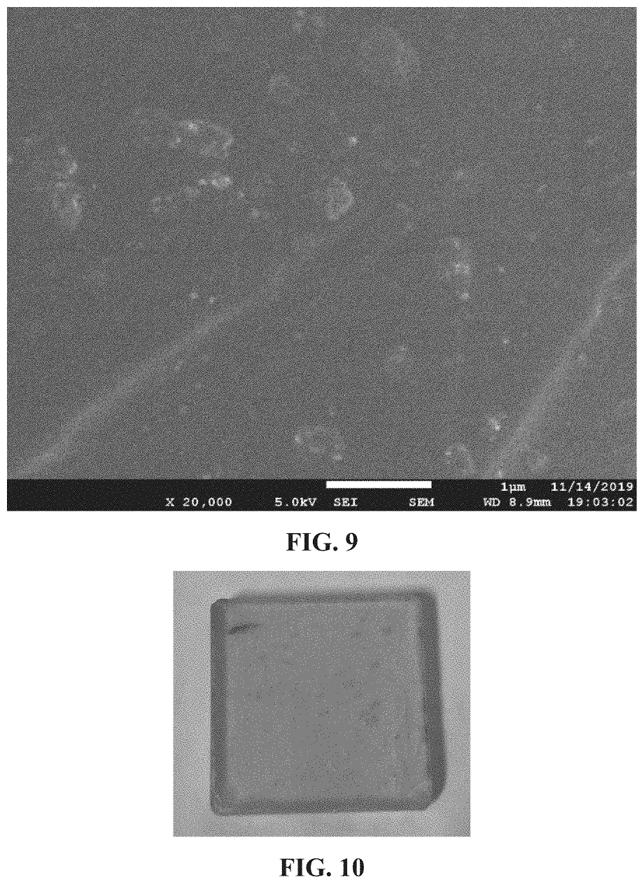

The scanning electron micrograph of the surface of the silicon-based glass-like material prepared in the example is shown in FIG. 9, which shows that the surface of the silicon-based glass is smooth and compact. A photograph of the silicon-based glass-like block prepared is shown in FIG. 10.

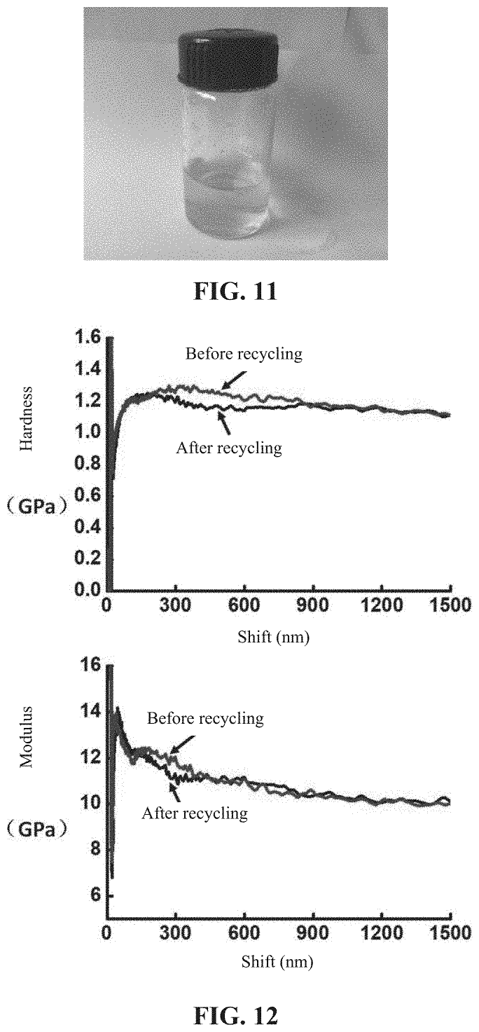

The glass-like block prepared in the example was dissolved in water at 50° C. to obtain a clear and transparent sol dispersion (as shown in FIG. 11). The sol dispersion was shaped after removing water at 60° C., and then the shaped sample was sintered to obtain a silicon-based glass-like block again. Thus, a cycle process of the glass-like block is completed, and this cycle process can be repeated at least 10 times.

FIG. 12 shows the initial hardness and modulus of a glass-like block and the hardness and modulus of a glass-like block obtained after 10 cycles as measured in the nanoindentation test by continuous stiffness measurement. As can be seen from FIG. 12, the hardness and modulus of the glass-like block remains almost unchanged before and after recycling, and the hardness is maintained at about 1.3 Gpa and the modulus is maintained at about 13 Gpa.

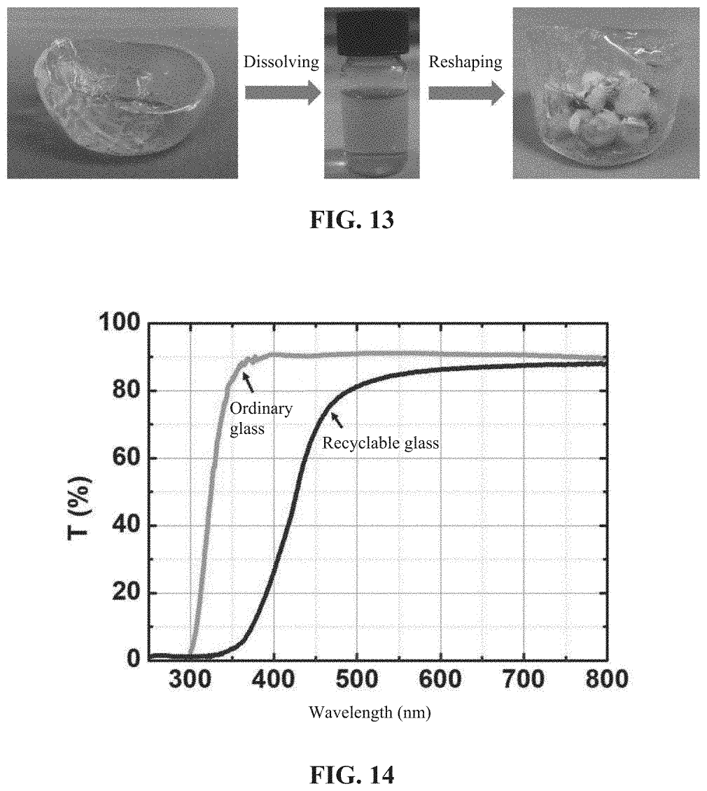

The glass-like block prepared in the example was placed in 100° C. vapor atmosphere and simultaneously placed on the surface of a mold with a certain shape as a conforming template, thus giving a glass-like ware having a shape of the template. After dissolving in water under a heating condition, the glass-like ware was subjected to molding process at 60° C. and simultaneously placed on the surface of a mold with another shape as a conforming template, thus giving glass ware with a different shape (as shown in FIG. 13) and realizing the recycling of glass.

As shown in FIG. 14, the glass-like block prepared in the example was subjected to a transmittance test using a LAMBDA 950 UV-visible spectrophotometer within the wavelength range of 300-800 nm, and the results show that it has a transmittance of about 85% in the visible light band and a transmittance of about 10% in the ultraviolet light band, and thus has a certain anti-UV function.

Tested by a heat conductometer, the glass-like block prepared in the example has a heat conductivity coefficient lower than that of common glass, and is suitable for transparent heat-insulating glass of buildings.

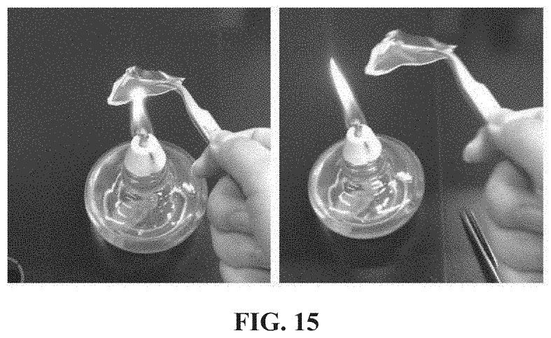

The glass-like block prepared in the example was placed on the flame of an alcohol lamp to be burned for 6 min, and no open flame or even smoke was generated on the surface of the glass, which shows that the glass has excellent fire resistance (as shown in FIG. 15).

### EXAMPLE B2

1) Under the catalysis of hydrochloric acid, dodecyltriethoxysilane was dissolved in ethanol, and then the mixture was heated at 70° C. and stirred at a rate of 1000 rpm for 8 h to obtain a ydrolytic dispersion of dodecyltriethoxysilane, namely hydrolysate (a), wherein the mass ratio of hydrochloric acid to dodecyltriethoxysilane to ethanol was 1:150:500.

2) Triethylamine as an organic base was dissolved in ethanol to obtain a solution of triethylamine in ethanol, namely solution (b), wherein the mass ratio of triethylamine to ethanol was 1:500.

3) Methyl silicone resin (2.5 g) with a weight-average molecular weight of 10,000 as a low-surface-energy polymer was dissolved in acetone (200 mL), and then the mixture was magnetically stirred at room temperature at a rate of 3000 rpm for 5 days to obtain a methyl silicone resin solution, namely solution ©.

4) γ-aminopropyltriethoxysilane was added into the solvent ethanol to obtain a dispersion, namely dispersion (d), wherein the mass ratio of γ-aminopropyltriethoxysilane to ethanol was 1:200.

5) The hydrolysate (a) prepared in the step 1) and the solution (b) prepared in the step 2) were blended in a mass ratio of 100:1 to obtain a mixed dispersion ©.

6) The mixed dispersion © prepared in the step 5), the solution © prepared in the step 3) and the dispersion (d) prepared in the step 4) were blended in a mass ratio of 1000:1:100 to obtain a mixed sol dispersion, namely dispersion (f), the pH of which was 10.0.

7) The dispersion (f) was placed into any mold and then subjected to heat treatment at 100° C. for 3 h to obtain a silicon-based glass-like gel block.

8) The glass-like gel block was sintered at 400° C. for 1 h under nitrogen atmosphere to obtain a reusable silicon-based glass-like block.

### EXAMPLE B3

1) Under the catalysis of hydrochloric acid, propyltriethoxysilane was dissolved in ethanol, and then the mixture was heated at 60° C. and stirred at a rate of 800 rpm for 7 h to obtain a hydrolysate of propyltriethoxysilane, namely hydrolysate (a), wherein the mass ratio of hydrochloric acid to propyltriethoxysilane to ethanol was 3:400:700.

2) Triethylamine as an organic base was dissolved in ethanol to obtain a solution of triethylamine in ethanol, namely solution (b), wherein the mass ratio of triethylamine to ethanol was 1:600.

3) Phenyl vinyl silicone resin (5 g) with a weight-average molecular weight of 10,000 as a low-surface-energy polymer was dissolved in methyl butanone (500 mL), and then the mixture was magnetically stirred at room temperature at a rate of 2000 rpm for 6 days to obtain a phenyl vinyl silicone resin solution, namely solution ©. 4) γ-mercaptopropyltrimethoxysilane was added into the solvent ethanol to obtain dispersion (d), wherein the mass ratio of γ-mercaptopropyltrimethoxysilane to ethanol was 1:400.

5) The hydrolysate (a) prepared in the step 1) and the dispersion (b) prepared in the step 2) were blended in a mass ratio of 30:1 to obtain a mixed dispersion ©.

6) The mixed dispersion © prepared in the step 5), the solution © prepared in the step 3) and the dispersion (d) prepared in the step 4) were blended in a mass ratio of 1000:1:50 to obtain dispersion (f), the pH of which was 9.5.

7) The dispersion (f) was placed into any mold and then subjected to heat treatment at 100° C. for 5 h to obtain a silicon-based glass-like gel block.

8) The glass-like gel block was sintered at 400° C. for 3 h under nitrogen atmosphere to obtain a reusable silicon-based glass-like block.

### EXAMPLE B4

1) Under the catalysis of hydrochloric acid, phenyltriethoxysilane was dissolved in ethanol, and then the mixture was heated at 80° C. and stirred at a rate of 1000 rpm for 7 h to obtain a hydrolysate of phenyltriethoxysilane, namely hydrolysate (a), wherein the mass ratio of hydrochloric acid to phenyltriethoxysilane to ethanol was 1:400:900.

2) Diphenylamine as an organic base was dissolved in ethanol to obtain a solution of diphenylamine in ethanol, namely solution (b), wherein the mass ratio of diphenylamine to ethanol was 1:600.

3) Polytrifluoropropylmethylsiloxane (10 g) with a weight-average molecular weight of 10,000 as a low-surface-energy polymer was dissolved in methyl acetate (500 mL), and then the mixture was magnetically stirred at room temperature at a rate of 2000 rpm for 8 days to obtain a polytrifluoropropylmethylsiloxane solution, namely solution ©.

4) 3-(2-aminoethylamino)propyltrimethoxysilane was added into the solvent ethanol to obtain dispersion (d), wherein the mass ratio of 3-(2-aminoethylamino)propyltrimethoxysilane to ethanol was 1:300.

5) The hydrolysate (a) prepared in the step 1) and the solution (b) prepared in the step 2) were blended in a mass ratio of 50:1 to obtain a mixed dispersion ©.

6) The mixed dispersion © prepared in the step 5), the solution © prepared in the step 3) and the solution (d) prepared in the step 4) were blended in a mass ratio of 800:1:100 to obtain dispersion (f), the pH of which was 8.5.

7) The dispersion (f) was placed into any mold and then subjected to heat treatment at 100° C. for 3 h to obtain a silicon-based glass-like gel block.

8) The glass-like gel block was sintered at 400° C. for 1 h under nitrogen atmosphere to obtain a reusable silicon-based glass-like block.

### EXAMPLE B5

1) Under the catalysis of hydrochloric acid, ethyltriethoxysilane was dissolved in ethanol, and then the mixture was heated at 90° C. and stirred at a rate of 1000 rpm for 8 h to obtain a hydrolysate of ethyltriethoxysilane, namely hydrolysate (a), wherein the mass ratio of hydrochloric acid to ethyltriethoxysilane to ethanol was 1:150:600.

2) Aniline as an organic base was dissolved in ethanol to obtain a solution of aniline in ethanol, namely solution (b), wherein the mass ratio of aniline to ethanol was 1:800.

3) Polytetrafluoroethylene resin (25 g) with a weight-average molecular weight of 10,000 as a low-surface-energy polymer was dissolved in propyl acetate (1000 mL), and then the mixture was magnetically stirred at room temperature at a rate of 2000 rpm for 5 days to obtain a polytetrafluoroethylene solution, namely solution ©.

4) γ-(methacryloyloxy)propyltrimethoxysilane was added into the solvent ethanol to obtain dispersion (d), wherein the mass ratio of γ-(methacryloyloxy)propyltrimethoxysilane to ethanol was 1:500.

5) The hydrolysate (a) prepared in the step 1) and the solution (b) prepared in the step 2) were blended in a mass ratio of 50:1 to obtain a mixed dispersion ©.

6) The mixed dispersion © prepared in the step 5), the solution © prepared in the step 3) and the solution (d) prepared in the step 4) were blended in a mass ratio of 600:1:100 to obtain dispersion (f), the pH of which was 9.0.

7) The dispersion (f) was placed into any mold and then subjected to heat treatment at 100° C. for 3 h to obtain a silicon-based glass-like gel block.

8) The glass-like gel block was sintered at 400° C. for 1 h under nitrogen atmosphere to obtain a reusable silicon-based glass-like block.

### EXAMPLE B6

1) Under the catalysis of hydrochloric acid, γ-mercaptopropyltrimethoxysilane was dissolved in ethanol, and then the mixture was heated at 90° C. and stirred at a rate of 2000 rpm for 8 h to obtain a hydrolysate of γ-mercaptopropyltrimethoxysilane, namely hydrolysate (a), wherein the mass ratio of hydrochloric acid to γ-mercaptopropyltrimethoxysilane to ethanol was 6:2500:3000.

2) Trimethylamine as an organic base was dissolved in ethanol to obtain a solution of trimethylamine in ethanol, namely solution (b), wherein the mass ratio of trimethylamine to ethanol was 1:800.

3) Phenyl epoxy silicone resin (15 g) with a weight-average molecular weight of 10,000 as a low-surface-energy polymer was dissolved in methyl isobutyl ketone (1000 mL), and then the mixture was magnetically stirred at room temperature at a rate of 2000 rpm for 10 days to obtain a phenyl epoxy silicone resin solution, namely solution ©. 4) Diethylaminomethyltriethoxysilane was added into the solvent ethanol to obtain dispersion (d), wherein the mass ratio of diethylaminomethyltriethoxysilane to ethanol was 1:800.

5) The hydrolysate (a) prepared in the step 1) and the solution (b) prepared in the step 2) were blended in a mass ratio of 50:1 to obtain a mixed dispersion ©.

6) The mixed dispersion © prepared in the step 5), the solution © prepared in the step 3) and the dispersion (d) prepared in the step 4) were blended in a mass ratio of 900:1:100 to obtain dispersion (f), the pH of which was 8.5.

7) The dispersion (f) was placed into any mold and then subjected to heat treatment at 100° C. for 3 h to obtain a silicon-based glass-like gel block.

8) The glass-like gel block was sintered at 400° C. for 1 h under nitrogen atmosphere to obtain a reusable silicon-based glass-like block.

The examples of the present invention have been described above. However, the present invention is not limited to the above examples. Any modification, equivalent replacement, improvement and the like made within the spirit and principle of the present invention shall fall within the protection scope of the present invention.

1. A combination system for preparing a self-healing coating material, characterized in that the combination system comprises: (A) a low-surface-energy polymer micelle dispersion; (B) a silane coupling agent hydrolysate; and (C) a base solution.

2. The combination system according to claim 1, characterized in that the combination system further comprises (D) a functional component, preferably the functional component is a functional small molecule, a functional polymer and/or a nanoparticle;
preferably, the functional component (D) is introduced into the system by itself, or is introduced into at least one of the component (A), component (B) or component (C) and further introduced into the system;
preferably, in the combination system, the mass ratio of the low-surface-energy polymer to the silane coupling agent to the base is 40:10:(1-7);
preferably, in the combination system, the mass ratio of the component (D) to the sum of the components (A), (B) and (C) is 1:50 to 1:10,000.

3. The combination system according to claim 1, characterized in that in the low-surface-energy polymer micelle dispersion, the low-surface-energy polymer is selected from at least one of fluorocarbon resin, silicone resin and fluorosilicone resin;
preferably, the fluorocarbon resin is selected from at least one of polytetrafluoroethylene (PTFE) resin, polyvinylidene fluoride (PVDF) resin, polychlorotrifluoroethylene (FEVE) resin and polyvinyl fluoride (PVF) resin;
preferably, the silicone resin is selected from at least one of methyl silicone resin, phenyl silicone resin, phenyl vinyl silicone resin, phenyl epoxy silicone resin, borosiloxane resin and poly-n-hexyl triphenyl ethynyl silane resin;
preferably, the fluorosilicone resin is selected from at least one of polytrifluoropropylmethylsiloxane, polymethylnonafluorohexylsiloxane, polytridecafluorooctylmethylsiloxane and polymethylheptadecafluorodecylsiloxane;
preferably, a solvent in the low-surface-energy polymer micelle dispersion is selected from alcohol, ketone and/or ester solvents;
preferably, the low-surface-energy polymer micelle dispersion comprises two solvents, namely solvent (a) and solvent (b), wherein, the solvent (a) is a solvent capable of dissolving the low-surface-energy polymer, and the solvent (b) is a solvent capable of initiating phase separation to form a low-surface-energy polymer micelle dispersion from a low-surface-energy polymer solution;
preferably, micelles in the low-surface-energy polymer micelle dispersion may be negatively or positively charged; when charged, the micelles are brought into a electrostatic equilibrium state by adding a silane coupling agent bearing opposite charges;
preferably, the silane coupling agent in the silane coupling agent hydrolysate is R₁Si(R₂)(OR)₂, wherein R₁ and R₂ are the same or different and are each independently selected from at least one of —RₐNH₂, —RₐSH, —N(Rₐ)₃, —RₐNR_{b}NH₂, 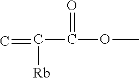
and —ORₐ, wherein Rₐ and R_{b} are the same or different and are each independently selected from C₁₋₈ alkyl, wherein R are the same or different and are each independently selected from C₁₋₈ alkyl, or
the silane coupling agent is a mixture of a silane coupling agent (a-1) and a silane coupling agent (a-2), wherein one or neither of R₁ and R₂ is OR in the silane coupling agent (a-1), both R₁ and R₂ are OR in the silane coupling agent (a-2), 0≤the content of the (a-2)<100%, and 0<the content of the (a-1)≤100%;
preferably, the silane coupling agent hydrolysate comprises solvent (c), wherein the solvent (c) is selected from at least one of acetone, methyl butanone, methyl isobutyl ketone, methyl acetate, ethyl acetate, propyl acetate, methanol, ethanol, isopropanol, toluene, cyclohexane, cyclohexanone, ethylene glycol monomethyl ether, ethylene glycol monoethyl ether and ethylene glycol monobutyl ether;
preferably, the silane coupling agent hydrolysate further comprises at least one of hydrochloric acid, sodium hydroxide and potassium hydroxide;
preferably, the pH of the component (C) is 7.5-8.5;
preferably, the base in the component (C) is a weak base, preferably an organic base.

4. A self-healing coating material, a self-healing coating or a self-healing article prepared from the combination system according to claim 1, wherein
preferably, the self-healing article comprises the self-healing coating;
preferably, the coating is a transparent coating having an average transmittance of 85% or more;
preferably, the coating has high hardness, and its pencil hardness is no less than 9 H;
preferably, the coating has a self-healing property.

5. A preparation method of the self-healing coating material according to claim 4, characterized in that the preparation method comprises:
blending a low-surface-energy polymer micelle dispersion (A), a silane coupling agent hydrolysate (B) and a base solution (C) to obtain the self-healing coating material; wherein
preferably, the method comprises:
1) dissolving a low-surface-energy polymer in solvent (a) to obtain a polymer solution;
2) adding solvent (b) into the polymer solution obtained in the step 1) for phase separation to obtain the low-surface-energy polymer micelle dispersion (A);
3) dissolving a silane coupling agent in solvent (c) and heating and stirring under the catalysis of hydrochloric acid, potassium hydroxide or sodium hydroxide to obtain the silane coupling agent hydrolysate (B);
4) dissolving a base in the solvent (b) to obtain the base solution (C); and
5) blending the low-surface-energy polymer micelle dispersion (A), the silane coupling agent hydrolysate (B) and the base solution (C) to obtain the self-healing coating material;
preferably, the method further comprises:
step 6): adding a functional component (D) into the self-healing coating material of the step 5).

6. A preparation method of the self-healing coating according to claim 5, further comprising:
coating the self-healing coating material on a substrate and performing heat treatment to obtain the self-healing coating, wherein
preferably, the substrate is selected from a transparent inorganic substrate and a transparent organic substrate;
preferably, the coating material is coated on any transparent substrate by a method selected from dipping, dip coating, spray coating, roll coating and brush coating;
preferably, the temperature of the heat treatment is 80-450° C. and the treatment time is 0.5-3 h;
preferably, the thickness of the coating is 0.5-5 μm.

7. A self-healing method of the self-healing coating or the self-healing article according to claim 4, characterized in that the self-healing method comprises: placing the self-healing coating or the self-healing article according to claim 4 with scratches on the surface in a mild water vapor environment for healing.

8. Use of the self-healing coating material according to claim 4 in preparing a self-healing coating or a self-healing article.

9. A composition system for use in a reusable glass-like material or glass-like article, characterized in that the composition system comprises:
(i) a mixed dispersion of a silane coupling agent hydrolysate and a base solution;
(ii) a low-surface-energy polymer solution; and
(iii) a silane coupling agent dispersion.

10. The composition system according to claim 9, characterized in that in the composition system, the mass ratio of the mixed dispersion of a silane coupling agent hydrolysate and a base solution (i), the low-surface-energy polymer solution (ii) and the silane coupling agent dispersion (iii) is (100-1500):1:(50-200);
preferably, the pH of the composition system is 8.5-14;
preferably, the mixed dispersion of a silane coupling agent hydrolysate and a base solution (i) comprises a silane coupling agent hydrolysate, an organic base and solvent (z), and the silane coupling agent hydrolysate is prepared from a silane coupling agent monomer by heating in the presence of a catalyst;
preferably, the siloxane monomer is selected from siloxanes having hydrophobic end groups, for example, from at least one of methyltriethoxysilane, ethyltriethoxysilane, propyltrimethoxysilane, propyltriethoxysilane, dodecyltriethoxysilane, dodecyltrimethoxysilane, γ-(methacryloyloxy)propyltrimethoxysilane, γ-(methacryloyloxy) propyltriethoxysilane, γ-mercaptopropyltrimethoxysilane, γ-mercaptopropyltriethoxysilane, phenyltrimethoxysilane, phenyltriethoxysilane, and the like;
preferably, the catalyst is selected from hydrochloric acid or from at least one of sodium hydroxide and potassium hydroxide;
preferably, the organic base is selected from at least one of dimethylamine, trimethylamine, ethylamine, triethylamine, benzylamine, aniline, p-toluidine, p-chloroaniline, p-nitroaniline, diphenylamine, pyridine, triethanolamine and urea;
preferably, the mixed dispersion comprises solvent (z), wherein the solvent (z) is selected from at least one of ethanol, acetone, methyl butanone, methyl isobutyl ketone, methyl acetate, ethyl acetate, propyl acetate, methanol, isopropanol, toluene, cyclohexane, cyclohexanone, ethylene glycol monomethyl ether, ethylene glycol monoethyl ether and ethylene glycol monobutyl ether;
preferably, the low-surface-energy polymer solution comprises a low-surface-energy polymer and solvent (x), wherein
the low-surface-energy polymer is selected from at least one of fluorocarbon resin, silicone resin and fluorosilicone resin; preferably, the solvent (x) is selected from ketone solvents and/or ester solvents;
preferably, the silane coupling agent dispersion comprises a silane coupling agent and solvent (y), wherein
the silane coupling agent is R₁Si(R₂)(OR)₂, wherein R₁ and R₂ are the same or different and are each independently selected from at least one of —RₐNH₂, —RₐSH, —N(Rₐ)₃, —RₐNR_{b}NH₂, 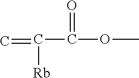
and —ORₐ, wherein Rₐ and R_{b} are the same or different and are each independently selected from C₁₋₈ alkyl, or
the silane coupling agent is a mixture of a silane coupling agent (a-1) and a silane coupling agent (a-2), wherein one or neither of R₁ and R₂ is OR in the silane coupling agent (a-1), both R₁ and R₂ are OR in the silane coupling agent (a-2), 0≤the content of the (a-2)≤100%, and 0<the content of the (a-1)≤100%;
preferably, the silane coupling agent is selected from at least one of γ-aminopropyltriethoxysilane, diethylaminomethyltriethoxysilane, 3-(2-aminoethylamino)propyltriethoxysilane, 3-(2-aminoethylamino) propyltrimethoxysilane, γ-(methacryloyloxy)propyltrimethoxysilane and γ-mercaptopropyltrimethoxysilane;
preferably, the solvent (y) is selected from at least one of acetone, methyl butanone, methyl isobutyl ketone, methyl acetate, ethyl acetate, propyl acetate, methanol, ethanol, isopropanol, toluene, cyclohexane, cyclohexanone, ethylene glycol monomethyl ether, ethylene glycol monoethyl ether and ethylene glycol monobutyl ether.

11. A directly reusable glass-like material or glass-like article prepared from the composition system according to claim 9.

12. A preparation method of the directly reusable glass-like material or glass-like article according to claim 11, characterized in that the preparation method comprises:
mixing a mixed dispersion of a silane coupling agent hydrolysate and a base solution (i), a low-surface-energy polymer solution (ii) and a silane coupling agent dispersion (iii) to obtain a mixed system, and performing heat treatment and sintering on the mixed system to obtain the glass-like material or glass-like article.

13. The preparation method according to claim 12, characterized in that the preparation method comprises:
A1) mixing a silane coupling agent hydrolysate with an organic base solution to obtain the mixed dispersion (i), wherein
preferably, the silane coupling agent hydrolysate is prepared from a siloxane monomer under catalytic heating conditions;
A2) dissolving a low-surface-energy polymer in solvent (x) to obtain the low-surface-energy polymer solution (ii);
A3) dissolving a silane coupling agent in solvent (y) and stirring at room temperature to obtain the silane coupling agent dispersion (iii);
A4) mixing the mixed dispersion of the silane coupling agent hydrolysate and the base solution (i), the low-surface-energy polymer solution (ii) and the silane coupling agent dispersion (iii) to obtain a mixed system;
A5) performing heat treatment on the mixed system to obtain a silicon-based glass-like gel; and
A6) sintering the silicon-based glass-like gel to obtain the glass-like material or glass-like article.

14. A recycling method of the glass-like material or glass-like article according to claim 11, characterized in that the recycling method comprises: dissolving the glass-like material or glass-like article in water or an aqueous solvent and recycling the obtained sol dispersion, wherein
preferably, the aqueous solvent is selected from a mixed solvent of water and an organic solvent.

15. A reutilization method of the glass-like material or glass-like article, characterized in that the reutilization method comprises: performing heat treatment on the recycled sol dispersion according to claim 14 and then sintering to obtain the glass-like material or glass-like article.

16. Use of the composition system according to claim 9 in preparing a reusable glass-like material or glass-like article.

17. A shaping method of the glass-like material or glass-like article according to claim 11, characterized in that the shaping method comprises: placing the glass-like material or glass-like article into a template, and shaping the glass-like material or glass-like article under 90-150° C. water vapor atmosphere.
